(19) United States
(12) Patent Application Publication
(10) Pub. No.: US 2025/0085584 A1
(43) Pub. Date: Mar. 13, 2025

(54) LIGHT ADJUSTMENT DEVICE AND VEHICLE

(71) Applicants: Beijing BOE Sensor Technology Co., Ltd., Beijing (CN); BOE TECHNOLOGY GROUP CO., LTD., Beijing (CN)

(72) Inventors: Peng LIANG, Beijing (CN); Changyin WANG, Beijing (CN); Juan CHEN, Beijing (CN); Xiaolong WU, Beijing (CN); Sikai ZHANG, Beijing (CN); Deshen ZHAI, Beijing (CN); Xiaoqian JU, Beijing (CN); Ying WANG, Beijing (CN); Zhan LI, Beijing (CN); Chunlei WANG, Beijing (CN); Yuanyang ZHAO, Beijing (CN)

(21) Appl. No.: 18/294,344

(22) PCT Filed: Oct. 8, 2022
(86) PCT No.: PCT/CN2022/123846

§ 371 Date: Feb. 1, 2024

(51) Int. Cl. G02F 1/1335; B60J 3/00; B60J 3/04; E06B 9/24

(52) U.S. Cl. CPC G02F 1/133512; B60J 3/007; B60J 3/04; E06B 9/24; E06B 2009/2464; G02F 2202/28

(57) ABSTRACT

A light adjustment device includes a first substrate and a second substrate that are arranged opposite to each other, a light adjustment module, and an ultraviolet light blocking layer. The light adjustment module is located between the first substrate and the second substrate. The ultraviolet light blocking layer is located between the first substrate and the light adjustment module or located inside the light adjustment module. A refractive index of the ultraviolet light blocking layer is greater than a refractive index of the first substrate.

### CROSS-REFERENCE TO RELATED APPLICATION

This application is a national phase entry under 35 USC 371 of International Patent Application No. PCT/CN2022/123846, filed on Oct. 8, 2022, which is incorporated herein by reference in its entirety.

### TECHNICAL FIELD

The present disclosure relates to the field of light adjustment technologies, and in particular, to a light adjustment device and a vehicle.

### BACKGROUND

With the development of light adjustment technologies, light adjustment devices are more and more widely used in the fields of construction and transportation. The light adjustment devices include polymer dispersed liquid crystal (PDLC) light adjustment devices, electrochromism (EC) light adjustment devices, dye liquid crystal light adjustment devices, or suspended particle light adjustment devices.

### SUMMARY

In an aspect, a light adjustment device is provided. The light adjustment device includes a first substrate and a second substrate that are arranged opposite to each other, a light adjustment module, and an ultraviolet light blocking layer. The light adjustment module is located between the first substrate and the second substrate. The ultraviolet light blocking layer is located between the first substrate and the light adjustment module, or is disposed in the light adjustment module. A refractive index of the ultraviolet light blocking layer is greater than a refractive index of the first substrate.

In some embodiments, the ultraviolet light blocking layer is disposed on a surface of the light adjustment module proximate to the first substrate. The light adjustment device further includes a first adhesive layer, and the first adhesive layer is located between the ultraviolet light blocking layer and the first substrate. A refractive index of the first adhesive layer is greater than the refractive index of the first substrate, and is less than the refractive index of the ultraviolet light blocking layer.

In some embodiments, the refractive index of the first substrate is in a range of 1.3 to 1.5; and/or, the refractive index of the first adhesive layer is in a range of 1.4 to 1.5; and/or, the refractive index of the ultraviolet light blocking layer is in a range of 1.4 to 1.6.

In some embodiments, the light adjustment module includes a first base material layer and a second base material layer that are arranged opposite to each other, and the first base material layer is closer to the first substrate than the second base material layer. The ultraviolet light blocking layer is disposed on a surface of the first base material layer away from the second base material layer. A thermal expansion coefficient of the ultraviolet light blocking layer is approximately the same as a thermal expansion coefficient of the first base material layer; and/or, a heat shrinkage of the ultraviolet light blocking layer is approximately the same as a heat shrinkage of the first base material layer.

In some embodiments, the thermal expansion coefficient of the ultraviolet light blocking layer is less than or equal to 50 ppm/K; and/or the heat shrinkage of the ultraviolet light blocking layer is less than or equal to 0.1%.

In some embodiments, the ultraviolet light blocking layer is disposed on a surface of the first substrate proximate to the light adjustment module. The light adjustment device further includes a first adhesive layer, and the first adhesive layer is located between the ultraviolet light blocking layer and the light adjustment module. A refractive index of the first adhesive layer is greater than the refractive index of the ultraviolet light blocking layer.

In some embodiments, the refractive index of the first substrate is in a range of 1.3 to 1.5; and/or, the refractive index of the ultraviolet light blocking layer is in a range of 1.4 to 1.5; and/or, the refractive index of the first adhesive layer is in a range of 1.4 to 1.6.

In some embodiments, an orthographic projection of the ultraviolet light blocking layer on a reference plane approximately coincides with an orthographic projection of the light adjustment module on the reference plane, and the reference plane is approximately parallel to a surface of the first substrate away from the light adjustment module.

In some embodiments, the light adjustment device further includes a first light-shielding layer. The first light-shielding layer is disposed on a surface of the first substrate away from the light adjustment module or a surface of the first substrate proximate to the light adjustment module, and is arranged along an edge of the first substrate. A boundary of an orthographic projection of the ultraviolet light blocking layer on a reference plane approximately coincides with an inner boundary of an orthographic projection of the first light-shielding layer on the reference plane. The reference plane is approximately parallel to the surface of the first substrate away from the light adjustment module.

In some embodiments, the light adjustment device further includes a sealant. The sealant is located between the first substrate and the second substrate, and surrounds the light adjustment module, the first adhesive layer and the ultraviolet light blocking layer.

In some embodiments, an orthographic projection of the ultraviolet light blocking layer on a reference plane approximately coincides with an orthographic projection of the first substrate on the reference plane. The reference plane is approximately parallel to a surface of the first substrate away from the light adjustment module.

In some embodiments, the light adjustment device further includes a sealant. The sealant is located between the ultraviolet light blocking layer and the second substrate, and surrounds the light adjustment module and the first adhesive layer.

In some embodiments, the light adjustment module includes a first base material layer, a first electrode layer, a light adjustment layer, a second electrode layer and a second base material layer that are sequentially stacked, and the first base material layer is closer to the first substrate than the second base material layer. The ultraviolet light blocking layer is located between the first base material layer and the first electrode layer, and a material of the ultraviolet light blocking layer includes cerium dioxide and titanium dioxide.

In some embodiments, a material of the ultraviolet light blocking layer includes an ultraviolet blocking optical adhesive; and/or the material of the ultraviolet light blocking layer includes cerium dioxide and titanium dioxide.

In some embodiments, in a case where the material of the ultraviolet light blocking layer includes the ultraviolet blocking optical adhesive, a thickness of the ultraviolet light blocking layer is in a range of 50 μm to 200 μm. In a case where the material of the ultraviolet light blocking layer includes cerium dioxide and titanium dioxide, the thickness of the ultraviolet light blocking layer is in a range of 400 nm to 600 nm.

In some embodiments, the light adjustment device includes a first adhesive layer and a second adhesive layer, the first adhesive layer is disposed between the light adjustment module and the first substrate, and the second adhesive layer is disposed between the light adjustment module and the second substrate. A material of the first adhesive layer includes a polyvinyl butyral (PVB) adhesive or a transparent optical adhesive; and/or, a material of the second adhesive layer includes a PVB adhesive or a transparent optical adhesive.

In some embodiments, the material of the first adhesive layer includes the PVB adhesive, an orthographic projection of the first adhesive layer on a reference plane approximately coincides with an orthographic projection of the light adjustment module on the reference plane, and the reference plane is approximately parallel to a surface of the first substrate away from the light adjustment module. In a case where the light adjustment device further includes a sealant, the sealant surrounds the light adjustment module and the first adhesive layer, and is connected to a circumferential sidewall of the light adjustment module and a circumferential sidewall of the first adhesive layer.

In some embodiments, the material of the first adhesive layer includes the transparent optical adhesive; an orthographic projection of the first adhesive layer on a reference plane is located within an orthographic projection of the light adjustment module on the reference plane, and has a distance from a boundary of the orthographic projection of the light adjustment module on the reference plane; the reference plane is approximately parallel to a surface of the first substrate away from the light adjustment module. The light adjustment device further includes a first frame sealing adhesive, and the first frame sealing adhesive is disposed around the first adhesive layer and bonded to a circumferential sidewall of the first adhesive layer. In a case where the light adjustment device further includes a sealant, the sealant surrounds the light adjustment module and the first frame sealing adhesive, and is connected to a circumferential sidewall of the light adjustment module and a surface of the first frame sealing adhesive away from the first adhesive layer.

In some embodiments, the material of the second adhesive layer includes the PVB adhesive, an orthographic projection of the second adhesive layer on a reference plane approximately coincides with an orthographic projection of the light adjustment module on the reference plane, and the reference plane is approximately parallel to a surface of the first substrate away from the light adjustment module. In a case where the light adjustment device further includes a sealant, the sealant surrounds the light adjustment module and the second adhesive layer, and is connected to a circumferential sidewall of the light adjustment module and a circumferential sidewall of the second adhesive layer.

In some embodiments, the material of the second adhesive layer includes the transparent optical adhesive; an orthographic projection of the second adhesive layer on a reference surface is located within an orthographic projection of the light adjustment module on the reference plane, and has a distance from a boundary of the orthographic projection of the light adjustment module on the reference plane. The light adjustment device further includes a second frame sealing adhesive, and the second frame sealing adhesive is disposed around the second adhesive layer and bonded to a circumferential sidewall of the second adhesive layer. In a case where the light adjustment device further includes a sealant, the sealant surrounds the light adjustment module and the second frame sealing adhesive, and is connected to a circumferential sidewall of the light adjustment module and a surface of the second frame sealing adhesive away from the second adhesive layer.

In another aspect, a vehicle is provided. The vehicle includes a vehicle body and a vehicle window glass mounted on the vehicle body, and the vehicle window glass includes the light adjustment device as described in any one of the above embodiments. The first substrate is closer to an outside of the vehicle than the second substrate.

### BRIEF DESCRIPTION OF THE DRAWINGS

In order to describe technical solutions in the present disclosure more clearly, the accompanying drawings to be used in some embodiments of the present disclosure will be introduced briefly. However, the accompanying drawings to be described below are merely some embodiments of the present disclosure, and a person of ordinary skill in the art can obtain other drawings according to those drawings. In addition, the accompanying drawings to be described below may be regarded as schematic diagrams but are not limitations on actual sizes of products, actual processes of methods and actual timings of signals involved in the embodiments of the present disclosure.

FIG. 1 is a structural diagram of a light adjustment device, in accordance with some embodiments;

FIG. 2A is a structural diagram of a light adjustment module, in accordance with some embodiments;

FIG. 2B is a structural diagram of another light adjustment module, in accordance with some embodiments;

FIG. 3 is a structural diagram of another light adjustment device, in accordance with some embodiments;

FIG. 4 is a structural diagram of yet another light adjustment device, in accordance with some embodiments;

FIG. 5 is a structural diagram of yet another light adjustment module, in accordance with some embodiments;

FIG. 6 is a structural diagram of yet another light adjustment module, in accordance with some embodiments;

FIG. 7 is a structural diagram of yet another light adjustment device, in accordance with some embodiments;

FIG. 8 is a structural diagram of yet another light adjustment device, in accordance with some embodiments;

FIG. 9 is a diagram showing steps of manufacturing a light adjustment device, in accordance with some embodiments;

FIG. 10 is a structural diagram of yet another light adjustment device, in accordance with some embodiments;

FIG. 11 is a diagram showing steps of manufacturing a light adjustment device, in accordance with some other embodiments;

FIG. 12 is a structural diagram of yet another light adjustment device, in accordance with some embodiments;

FIG. 13 is a diagram showing steps of manufacturing a light adjustment device, in accordance with yet some other embodiments;

FIG. 14 is a structural diagram of yet another light adjustment device, in accordance with some embodiments;

FIG. 15 is a structural diagram of yet another light adjustment device, in accordance with some embodiments;

FIG. 16 is a structural diagram of yet another light adjustment device, in accordance with some embodiments;

FIG. 17 is a structural diagram of yet another light adjustment device, in accordance with some embodiments;

FIG. 18 is a diagram showing steps of manufacturing a light adjustment device, in accordance with yet some other embodiments;

FIG. 19 is a structural diagram of yet another light adjustment device, in accordance with some embodiments;

FIG. 20 is a structural diagram of yet another light adjustment device, in accordance with some embodiments;

FIG. 21 is a diagram showing steps of manufacturing a light adjustment device, in accordance with yet some other embodiments;

FIG. 22 is a structural diagram of yet another light adjustment device, in accordance with some embodiments;

FIG. 23 is a diagram showing steps of manufacturing a light adjustment device, in accordance with yet some other embodiments;

FIG. 24 is a structural diagram of yet another light adjustment device, in accordance with some embodiments;

FIG. 25 is a diagram showing steps of manufacturing a light adjustment device, in accordance with yet some other embodiments;

FIG. 26 is a structural diagram of yet another light adjustment device, in accordance with some embodiments;

FIG. 27 is a structural diagram of yet another light adjustment device, in accordance with some embodiments;

FIG. 28 is a structural diagram of yet another light adjustment device, in accordance with some embodiments;

FIG. 29 is a diagram showing steps of manufacturing a light adjustment device, in accordance with yet some other embodiments;

FIG. 30 is a structural diagram of yet another light adjustment device, in accordance with some embodiments;

FIG. 31 is a structural diagram of yet another light adjustment device, in accordance with some embodiments;

FIG. 32 is a structural diagram of yet another light adjustment device, in accordance with some embodiments;

FIG. 33 is a diagram showing steps of manufacturing a light adjustment device, in accordance with yet some other embodiments; and

FIG. 34 is a structural diagram of a vehicle, in accordance with some embodiments.

### DETAILED DESCRIPTION

The technical solutions in some embodiments of the present disclosure will be described clearly and completely with reference to the accompanying drawings.

However, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to.” In the description of the specification, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

The terms “first” and “second” are used for descriptive purposes only, and are not to be construed as indicating or implying a relative importance or implicitly indicating a number of indicated technical features. Thus, a feature defined with “first” and “second” may explicitly or implicitly include one or more of the features. In the description of the embodiments of the present disclosure, the terms “a plurality of”, “the plurality of” and “multiple” each mean two or more unless otherwise specified.

The phrase “at least one of A, B and C” has a same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

As used herein, the term “if” is optionally construed as “when” or “in a case where”, depending on the context.

The use of the phrase “applicable to” or “configured to” herein means an open and inclusive expression, which does not exclude devices that are applicable to or configured to perform additional tasks or steps.

The term such as “about,” “substantially,” and “approximately” as used herein includes a stated value and an average value within an acceptable range of deviation of a particular value. The acceptable range of deviation is determined by a person of ordinary skill in the art, considering measurement in question and errors associated with measurement of a particular quantity (i.e., limitations of a measurement system).

The term such as “equal” as used herein includes a stated condition and a condition similar to the stated condition. A range of the similar condition is within an acceptable deviation range, and the acceptable deviation range is determined by a person of ordinary skill in the art, considering measurement in question and errors associated with measurement of a particular quantity (i.e., the limitations of a measurement system). For example, the term “equal” includes absolute equality and approximate equality, and an acceptable range of deviation of the approximate equality may be that, for example, a difference between the two that are equal is less than or equal to 5% of either of the two.

It will be understood that, in a case where a layer or component is referred to as being on another layer or substrate, it may be that the layer or component is directly on the another layer or substrate, or there may be intermediate layer(s) between the layer or component and the another layer or substrate.

Exemplary embodiments are described herein with reference to sectional views and/or plan views as idealized exemplary drawings. In the accompanying drawings, thicknesses of layers and areas of regions are enlarged for clarity. Variations in shape with respect to the accompanying drawings due to, for example, manufacturing technologies and/or tolerances may be envisaged. Therefore, the exemplary embodiments should not be construed as being limited to the shapes of the regions shown herein, but including shape deviations due to, for example, manufacturing. For example, an etched region shown to have a rectangular shape generally has a feature being curved. Thus, the regions shown in the accompanying drawings are schematic in nature, and their shapes are not intended to show actual shapes of the regions in a device, and are not intended to limit the scope of the exemplary embodiments.

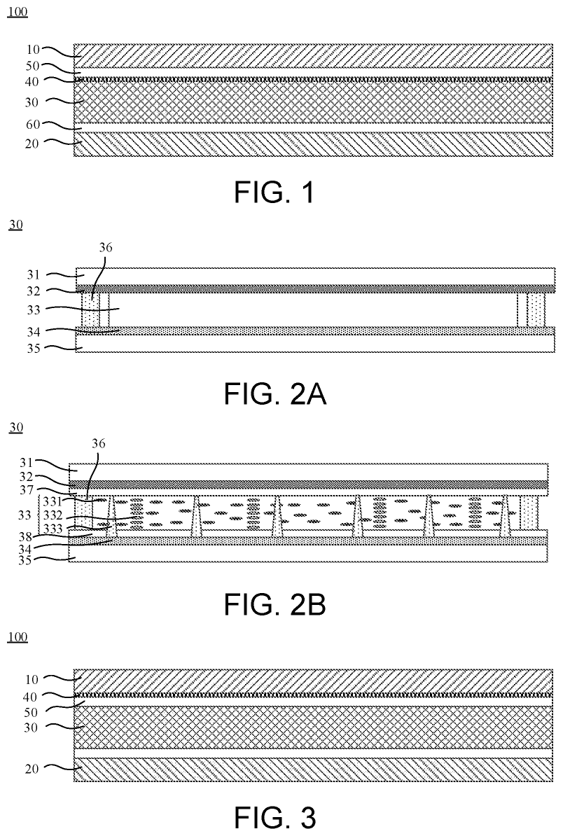

Some embodiments of the present disclosure provide a light adjustment device 100, and as shown in FIG. 1, the light adjustment device 100 includes a first substrate 10, a second substrate 20, and a light adjustment module 30.

The first substrate 10 and the second substrate 20 are arranged opposite to each other. Materials of the first substrate 10 and the second substrate 20 may each include a material with a high transmittance (for example, the transmittance is greater than 85%). For example, the material of the first substrate 10 may include tempered glass or plastic, which will not be described in details in the embodiments of the present disclosure. For example, the first substrate 10 is made of tempered glass, and a thickness of the tempered glass may be flexibly selected according to the thickness requirement of the light adjustment device 100. For example, the thickness of the tempered glass may be 2.1 mm. The material of the second substrate 20 and the material of the first substrate 10 may be the same. In this way, the uniformity of the materials in the light adjustment device 100 may be improved, thereby reducing the costs of the light adjustment device 100.

The light adjustment module 30 is located between the first substrate 10 and the second substrate 20, and the light adjustment module 30 is configured to adjust a transmittance of light. As shown in FIG. 2A, the light adjustment module 30 includes a first base material layer 31, a first electrode layer 32, a light adjustment layer 33, a second electrode layer 34, and a second base material layer 35 that are sequentially stacked, and a frame sealing adhesive 36 that is disposed between the first electrode layer 32 and the second electrode layer 34 and surrounds the light adjustment layer 33. The first base material layer 31 is closer to the first substrate 10 than the second base material layer 35.

A material of the first base material layer 31 may include a rigid material and a flexible material. For example, the rigid material may include glass. The flexible material may include one or more of polyethersulfone (PES), polyarylate (PAR), polyetherimide (PEI), polyethylene naphthalate (PEN), polyethylene terephthalate (PET), polyphenylene sulfide (PPS), polyimide (PI), polycarbonate (PC), triacetate cellulose (TAC) and cellulose acetate propionate (CAP), which will not be described in details in the embodiments of the present disclosure. For example, the material of the first base material layer 31 may include polyimide.

A material of the second base material layer 35 may be the same as the material of the first base material layer 31.

The first electrode layer 32 may be made of indium tin oxide, gallium oxide or silver nanowires, which will not be described in details in the embodiments of the present disclosure. The second electrode layer 34 may be made of the same material as the first electrode layer 32.

The light adjustment layer 33 may include dye liquid crystals, polymer dispersed liquid crystals, suspended particles or electrochromic materials, which will not be described in details in the embodiments of the present disclosure.

The embodiments of the present disclosure are illustrated by taking an example in which the light adjusting layer 33 includes dye liquid crystals. As shown in FIG. 2B, the light adjustment module 30 further includes a first alignment layer 37 and a second alignment layer 38. The first alignment layer 37 is located between the light adjustment layer 33 and the first electrode layer 32, and the second alignment layer 38 is located between the light adjustment layer 33 and the second electrode layer 34. The light adjustment layer 33 includes dye molecules 331, liquid crystal molecules 332 and a plurality of spacers 333 (in FIG. 2B, black ellipses represent the dye molecules, and white ellipses represent the liquid crystal molecules). The spacers 333 are located between the first alignment layer 37 and the second electrode layer 34, and penetrate through the second alignment layer 38.

The ultraviolet light of the natural light may cause the aging of the organic material in the light adjustment layer 33 of the light adjustment module 30, and the service life of the light adjustment module 30 is reduced, which results in a short service life of the light adjustment device 100.

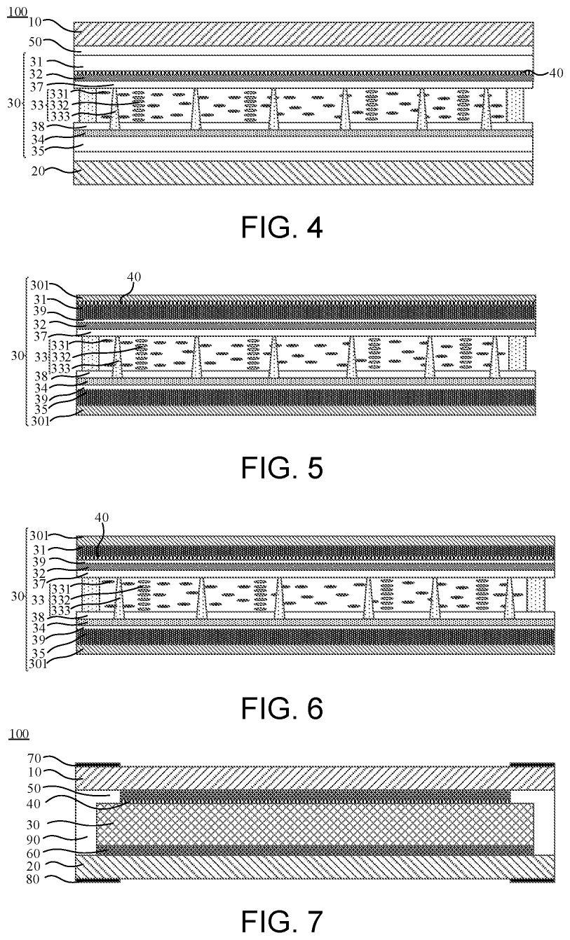

In order to solve the above problems, the embodiments of the present disclosure further include an ultraviolet light blocking layer 40; as shown in FIGS. 1 and 3, the ultraviolet light blocking layer 40 is located between the first substrate 10 and the light adjustment module 30; alternatively, as shown in FIG. 4, the ultraviolet light blocking layer 40 is disposed in the light adjustment module 30.

The ultraviolet light blocking layer 40 can block ultraviolet light (e.g., light with a wavelength less than 400 nm) or reduce the transmittance of ultraviolet light, but may allow light of other colors (light with a wavelength greater than 400 nm) to pass through. In this way, the ultraviolet light blocking layer 40 can reduce the ultraviolet light that enters the light adjustment device 100 from the first substrate 10 and enters the organic material (the light adjustment layer 33) of the light adjustment module 30. Therefore, the aging speed of the light adjustment module 30 is reduced, the service life of the light adjustment module 30 is increased, and the service life of the light adjustment device 100 is increased.

In some embodiments, a material of the ultraviolet light blocking layer 40 includes an ultraviolet blocking optical adhesive; and/or, the material of the ultraviolet light blocking layer 40 includes cerium dioxide and titanium dioxide.

In a case where the material of the ultraviolet light blocking layer 40 includes an ultraviolet blocking optical adhesive, a thickness of the ultraviolet light blocking layer 40 may be in a range of 50 μm to 200 μm. For example, the thickness of the ultraviolet light blocking layer 40 is 50 μm, 100 μm, or 200 μm, which will not be described in details in the embodiments of the present disclosure. For example, the thickness of the ultraviolet light blocking layer 40 may be 100 μm.

Since the ultraviolet light blocking optical adhesive is soft, the thickness of the ultraviolet light blocking layer 40 cannot be small. If the thickness of the ultraviolet light blocking layer 40 is small, the ultraviolet light blocking layer 40 and the first substrate 10 or the light adjustment module 30 are not easily bonded together. If the thickness of the ultraviolet light blocking layer 40 is large, it will result in a large thickness of the light adjustment device 100. Based on this, in the embodiments of the present disclosure, the thickness of the ultraviolet light blocking layer 40 is in a range of 50 μm to 200 μm.

At a temperature from −40° C. to 180° C., a thermal expansion coefficient of the ultraviolet blocking optical adhesive is less than 50 ppm/K, and a heat shrinkage of the ultraviolet blocking optical adhesive is less than 0.1%.

A transmittance of the ultraviolet blocking optical adhesive is greater than 95%, and a haze of the ultraviolet blocking optical adhesive is less than 5%. In this way, in a case where the material of the ultraviolet light blocking layer 40 includes the ultraviolet blocking optical adhesive, the transmittance of the light adjustment device 100 is high.

In a case where the material of the ultraviolet light blocking layer 40 includes cerium dioxide and titanium dioxide, the thickness of the ultraviolet light blocking layer 40 may be in a range of 400 nm to 600 nm. In this way, the light adjustment device 100 has a small thickness and a small weight. For example, the thickness of the ultraviolet light blocking layer 40 may be 400 nm, 550 nm, or 600 nm, which will not be described in details in the embodiments of the present disclosure. For example, the thickness of the ultraviolet light blocking layer 40 is 550 nm.

Cerium dioxide and titanium dioxide have good chemical stability, and have good and stable adhesion during the change of temperature of the environment. The transmittance of cerium dioxide and titanium dioxide is in a range of 75% to 85%. For example, the transmittance of cerium dioxide and titanium dioxide may be 75%, 81%, or 85%, which will not be described in details in the embodiments of the present disclosure. For example, the transmittance of cerium dioxide and titanium dioxide is 81%. A haze of cerium dioxide and titanium dioxide is less than 5%.

In a case where the ultraviolet light blocking layer 40 is located between the first substrate 10 and the light adjustment module 30, as shown in FIGS. 1 and 3, the ultraviolet light blocking layer 40 may reduce ultraviolet light of light that passes through the first substrate 10 to enter the light adjustment module 30. In this way, it may be possible to reduce the risk of the aging of the organic material in the light adjustment layer 33 of the light adjustment module 30, and in turn improve the service life of the light adjustment module 30 and improve the service life of the light adjustment device 100.

In a case where the ultraviolet light blocking layer 40 is located between the first substrate 10 and the light adjustment module 30, the material of the ultraviolet light blocking layer 40 may include the ultraviolet blocking optical adhesive, or the material of the ultraviolet light blocking layer 40 may include cerium dioxide and titanium dioxide. For example, the material of the ultraviolet light blocking layer 40 includes the ultraviolet blocking optical adhesive; or the material of the ultraviolet light blocking layer 40 includes cerium dioxide and titanium dioxide; or the material of the ultraviolet light blocking layer 40 includes the ultraviolet blocking optical adhesive, cerium dioxide and titanium dioxide.

In a case where the ultraviolet light blocking layer 40 is disposed in the light adjustment module 30, as shown in FIG. 4, the ultraviolet light blocking layer 40 is integrated into the light adjustment module 30, and the ultraviolet light blocking layer 40 may be disposed on a side of the light adjustment layer 33 proximate to the first substrate 10. In this way, the ultraviolet light blocking layer 40 can reduce the ultraviolet light that enters the light adjustment layer 33 from the first substrate 10.

In a case where the ultraviolet light blocking layer 40 is disposed in the light adjustment module 30, the material of the ultraviolet light blocking layer 40 includes cerium dioxide and titanium dioxide, and the thickness of the ultraviolet light blocking layer 40 is small. In this way, the light adjustment module 30 may be made to be thin and light.

As shown in FIG. 4, in a case where the first base material layer 31 is closer to the first substrate 10 than the second base material layer 35, the ultraviolet light blocking layer 40 may be disposed between the first base material layer 31 and the first electrode layer 32, so that the ultraviolet light blocking layer 40 may block the ultraviolet light between the first base material layer 31 and the first electrode layer 32. Therefore, the ultraviolet light entering into the light adjustment layer 33 is reduced, and the risk of the aging of the organic material in the light adjustment layer 33, so as to increase the service life of the light adjustment module 30 and in turn increase the service life of the light adjustment device 100.

In some embodiments, in a case where the material of the first base material layer 31 includes a flexible material, as shown in FIG. 5, the light adjustment module 30 may further include a hardened layer 39 that is disposed between the first electrode 32 and the first base material layer 31, and an encapsulation layer 301 that is disposed on a side of the first base material layer 31 away from the light adjustment layer 33. In this way, the ultraviolet light blocking layer 40 may be disposed between the encapsulation layer 301 and the first base material layer 31 (as shown in FIG. 5) or disposed between the first base material layer 31 and the hardened layer 39 (as shown in FIG. 6).

Therefore, it should be understood that, in a case where the light adjustment layer 33 further includes other film layers, the ultraviolet light blocking layer 40 may block the ultraviolet light outside the light adjustment layer 33 as long as the ultraviolet light blocking layer 40 is disposed on the side of the light adjustment layer 33 proximate to the first substrate 10.

In some embodiments, the refractive index of the ultraviolet light blocking layer 40 is greater than the refractive index of the first substrate 10. Therefore, it may be possible to increase the transparency of the light adjustment device 100 (i.e., improve the clarity when viewing objects through the light adjustment device 100), and reduce the haze of the light adjustment device 100.

In some embodiments, as shown in FIGS. 1 and 3, the light adjustment device 100 further includes a first adhesive layer 50 and a second adhesive layer 60. The first adhesive layer 50 is disposed between the first substrate 10 and the light adjustment module 30, and the second adhesive layer 60 is disposed between the second substrate 20 and the light adjustment module 30.

In some embodiments, the ultraviolet light blocking layer 40 is located between the first substrate 10 and the light adjustment module 30 includes the following two cases: the ultraviolet light blocking layer 40 is disposed on a surface of the light adjustment module 30 proximate to the first substrate 10 (as shown in FIG. 1); and the ultraviolet light blocking layer 40 is disposed on a surface of the first substrate 10 proximate to the light adjustment module 30 (as shown in FIG. 3).

In a case where the ultraviolet light blocking layer 40 is disposed on the surface of the light adjustment module 30 proximate to the first substrate 10, the first adhesive layer 50 is disposed between the first substrate 10 and the ultraviolet light blocking layer 40, and is used for bonding the first substrate 10 to the ultraviolet light blocking layer 40, so that the light adjustment module 30 is connected to the first substrate 10. In a case where the ultraviolet light blocking layer 40 is disposed on the surface of the first substrate 10 proximate to the light adjustment module 30, the first adhesive layer 50 is disposed between the ultraviolet light blocking layer 40 and the light adjustment module 30, and is used for bonding the ultraviolet light blocking layer 40 to the light adjustment module 30, so that the light adjustment module 30 is connected to the first substrate 10. In a case where the ultraviolet light blocking layer 40 is located between the first base material layer 31 and the first electrode layer 32, that is, the ultraviolet light blocking layer 40 is integrated into the light adjustment module 30, the first adhesive layer 50 is located between the light adjustment module 30 and the first substrate 10 and used for bonding the light adjustment module 30 to the first substrate 10. The second adhesive layer 60 is located between the second substrate 20 and the light adjustment module 30, and is used for bonding the second substrate 20 to the light adjustment module 30.

In some embodiments, as shown in FIG. 1, the ultraviolet light blocking layer 40 is disposed between the light adjustment module 30 and the first substrate 10, and is disposed on the surface of the light adjustment module 30 proximate to the first substrate 10. That is, the ultraviolet light blocking layer 40 is disposed on a surface of the first base material layer 31 away from the second base material layer 35. The thermal expansion coefficient of the ultraviolet light blocking layer 40 is approximately the same as the thermal expansion coefficient of first base material layer 31. The heat shrinkage of the ultraviolet light blocking layer 40 is approximately the same as the heat shrinkage of the first base material layer 31. In this way, it may be possible to reduce the risk of cracking caused by inconsistent expansion and shrinkage of the ultraviolet light blocking layer 40 and the first base material layer 31. For example, the thermal expansion coefficient of the ultraviolet light blocking layer 40 is less than or equal to 50 ppm/K. The heat shrinkage of the ultraviolet light blocking layer 40 is less than or equal to 0.1%.

In a case where the ultraviolet light blocking layer 40 is disposed on the surface of the light adjustment module 30 proximate to the first substrate 10, and the first adhesive layer 50 is located between the ultraviolet light blocking layer 40 and the first substrate 10, the refractive index of the first adhesive layer 50 is greater than the refractive index of the first substrate 10 and is less than the refractive index of the ultraviolet light blocking layer 40. In this way, along a light propagation direction, the refractive index of the first substrate 10, the refractive index of the first adhesive layer 50, and the refractive index of the ultraviolet light blocking layer 40 gradually increase. Therefore, the transparency of the light adjustment device 100 may be increased, and the haze of the light adjustment device 100 is reduced.

In some embodiments, the refractive index of the first substrate 10 is in a range of 1.3 to 1.5. For example, the refractive index of the first substrate 10 may be 1.3, 1.4 or 1.5, which will not be described in details in the embodiments of the present disclosure.

The refractive index of the first adhesive layer 50 is in a range of 1.4 to 1.5. The refractive index of the first adhesive layer 50 may be 1.4, 1.45 or 1.5, which will not be described in details in the embodiments of the present disclosure.

The refractive index of the ultraviolet light blocking layer 40 is in a range of 1.4 to 1.6. The refractive index of the ultraviolet light blocking layer 40 may be 1.4, 1.5 or 1.6, which will not be described in details in the embodiments of the present disclosure.

It should be understood that the refractive index of the first substrate 10, the refractive index of the first adhesive layer 50, and the refractive index of the ultraviolet light blocking layer 40 need to satisfy the above-mentioned refractive index range requirements, and also satisfy the requirement that the refractive index of the first substrate 10, the refractive index of the first adhesive layer 50, and the refractive index of the ultraviolet light blocking layer 40 gradually increase. For example, the refractive index of the first substrate 10 may be 1.3, the refractive index of the first adhesive layer 50 may be 1.4, and the refractive index of the ultraviolet light blocking layer 40 may be 1.5. Of course, the first substrate 10, the first adhesive layer 50 and the ultraviolet light blocking layer 40 may be arbitrarily selected according to the needs on the premise of satisfying the above requirements, which will not be described in details in the embodiments of the present disclosure.

In a case where the ultraviolet blocking layer 40 is disposed on the surface of the first substrate 10 proximate to the light adjustment module 30, and the first adhesive layer 50 is located between the ultraviolet light blocking layer 40 and the light adjustment module 30, the refractive index of the first adhesive layer 50 is greater than the refractive index of the ultraviolet light blocking layer 40, and the ultraviolet light blocking layer 40 is greater than the refractive index of the first substrate 10. In this way, along the light propagation direction, the refractive index of the first substrate 10, the refractive index of the ultraviolet light blocking layer 40, and the refractive index of the first adhesive layer 50 gradually increase. Therefore, the transparency of the light adjustment device 100 may be increased, and the haze of the light adjustment device 100 is reduced.

In some embodiments, the refractive index of the first substrate 10 is in a range of 1.3 to 1.5. For example, the refractive index of the first substrate 10 may be 1.3, 1.4 or 1.5, which will not be described in details in the embodiments of the present disclosure.

The refractive index of the ultraviolet light blocking layer 40 is in a range of 1.4 to 1.5. The refractive index of the ultraviolet light blocking layer 40 may be 1.4, 1.45 or 1.5, which will not be described in details in the embodiments of the present disclosure.

The refractive index of the first adhesive layer 50 is in a range of 1.4 to 1.6. The refractive index of the first adhesive layer 50 may be 1.4, 1.5 or 1.6, which will not be described in details in the embodiments of the present disclosure.

It should be understood that, the refractive index of the first substrate 10, the refractive index of the ultraviolet light blocking layer 40, and the refractive index of the first adhesive layer 50 need to satisfy the above-mentioned refractive index range requirements, and also satisfy the requirement that the refractive index of the first substrate 10, the refractive index of the ultraviolet light blocking layer 40, and the refractive index of the first adhesive layer 50 gradually increase. For example, the refractive index of the first substrate 10 may be 1.3, the refractive index of the ultraviolet light blocking layer 40 may be 1.4, and the refractive index of the first adhesive layer 50 may be 1.5. Of course, the first substrate 10, the ultraviolet light blocking layer 40 and the first adhesive layer 50 may be arbitrarily selected according to the needs on the premise of meeting the above requirements, which will not be described in details in the embodiments of the present disclosure.

It can be understood that, in a case where the ultraviolet light blocking layer 40 is disposed on the surface of the first substrate 10 proximate to the light adjustment module 30, the ultraviolet light blocking layer 40 may be directly formed on the surface of the first substrate 10, the process is more mature, and there is no need to consider the similarities and differences between the thermal expansion coefficient and heat shrinkage of the ultraviolet light blocking layer 40 and the first substrate 10.

In some embodiments, as shown in FIG. 4, in a case where the ultraviolet light blocking layer 40 is located between the first base material layer 31 and the first electrode layer 32, the first adhesive layer 50 is located between the light adjustment module 30 and the first substrate 10, and the refractive index of the first adhesive layer 50 is greater than the refractive index of the first substrate 10. For example, the refractive index of the first substrate 10 is in a range of 1.3 to 1.5. For example, the refractive index of the first adhesive layer 50 is in a range of 1.4 to 1.5. The refractive index of the first adhesive layer 50 may be 1.4, 1.45 or 1.5, which will not be described in details in the embodiments of the present disclosure.

It should be understood that the refractive index of the first substrate 10 and the refractive index of the first adhesive layer 50 need to satisfy the above-mentioned refractive index range requirements, and also satisfy that the refractive index of the first substrate 10 is less than the refractive index of the first adhesive layer 50. For example, the refractive index of the first substrate 10 may be 1.3, and the refractive index of the first adhesive layer 50 may be 1.4.

In some embodiments, an orthographic projection of the ultraviolet light blocking layer 40 on a reference plane approximately coincides with an orthographic projection of the light adjustment module 30 on the reference plane. That is, the light-adjusting module 30 is located in an orthographic projection, on a plane where the light adjustment module 30 is located, of the ultraviolet light blocking layer 40. In this way, the ultraviolet light blocking layer 40 may reduce the ultraviolet light directed to each position of the light adjustment module 30. Therefore, the aging speed of the organic material in the light adjustment module 30 may be reduced, and the service life of the light adjustment module 30 may be improved. The reference plane is approximately parallel to the surface of the first substrate 10 away from the light adjustment module 30.

In some embodiments, as shown in FIG. 7, the light adjustment device 100 further includes a first light-shielding layer 70 and a second light-shielding layer 80. The first light-shielding layer 70 is disposed on a surface of the first substrate 10 away from the light adjustment module 30 or a surface of the first substrate 10 proximate to the light adjustment module 30, and is arranged along an edge of the first substrate 10. The second light-shielding layer 80 is disposed on a surface of the second substrate 20 away from the light adjustment module 30 or a surface of the second substrate 20 proximate to the light adjustment module 30, and is arranged along an edge of the second substrate 20. The embodiments of the present disclosure are described by taking an example in which the first light-shielding layer 70 is disposed on the surface of the first substrate 10 away from the light adjustment module 30, and the second light-shielding layer 80 is disposed on the surface of the second substrate 20 away from the light adjustment module 30.

It can be understood that the light-shielding layers (the first light-shielding layer 70 and the second light-shielding layer 80) may be formed by applying ink on the edges of the substrates (the first substrate 10 and the second substrate 20). The thicknesses of the light-shielding layers are very small, the thicknesses of the light-shielding layers in the drawings are only to show the positional relationship between the light-shielding layers and the substrates, and there is no step or step difference between the substrates and the light-shielding layers.

In some embodiments, as shown in FIG. 7, a boundary of the orthographic projection of the ultraviolet light blocking layer 40 on the reference plane approximately coincides with an inner boundary of an orthographic projection of the first light-shielding layer 70 on the reference plane. In this way, in the light adjustment module 30, a portion whose orthographic projection on the reference plane coincides with the orthographic projection of the ultraviolet light blocking layer 40 on the reference plane may be blocked (protected) by the ultraviolet light blocking layer 40. The remaining portion may be blocked by the first light-shielding layer. Therefore, the material of the ultraviolet light blocking layer 40 may be saved. The orthographic projection of the light adjustment module 30 on the reference plane is located within orthographic projections of the ultraviolet light blocking layer 40 and the first light-shielding layer 70 on the reference plane. That is, the ultraviolet light blocking layer 40 and the first light-shielding layer 70 together reduce the ultraviolet light incident on the light adjustment module 30.

It can be understood that, in order to reduce the alignment accuracy between the first light-shielding layer 70 and the ultraviolet light blocking layer 40, as well as the manufacturing accuracy, at least part of an edge of the orthographic projection of the ultraviolet light blocking layer 40 on the reference plane may be located within the orthographic projection of the first light-shielding layer 70 on the reference plane.

In some embodiments, the light adjustment device 100 further includes a sealant 90. The sealant 90 is located between the first substrate 10 and the second substrate 20, and surrounds the light adjustment module 30, the first adhesive layer 50 and the ultraviolet light blocking layer 40. The sealant 90 may reduce the risk of damage of the light adjustment module 30 caused by water vapor in the air entering the light adjustment module 30.

For example, the cure shrinkage of the sealant 90 is less than 1%, the coefficient of thermal expansion of the sealant 90 is less than 100 ppm/K, and the heat shrinkage of the sealant 90 is less than 0.1%.

In some embodiments, in a case where the ultraviolet light blocking layer 40 is disposed on the surface of the first substrate 10 proximate to the light adjustment module 30, the orthographic projection of the ultraviolet light blocking layer 40 on the reference plane approximately coincides with an orthographic projection of the first substrate 10 on the reference plane.

In a case where the light adjustment device 100 further includes the sealant 90, the sealant 90 is located between the ultraviolet light blocking layer 40 and the second substrate 20 and surrounds the light adjustment module 30 and the first adhesive layer 50.

In some embodiments, a material of the first adhesive layer 50 may include a polyvinyl butyral (PVB) adhesive, a transparent optical adhesive (such as an optically clear adhesive (OCA) or an optically clear resin (OCR)), or an ethylene vinyl acetate copolymer (EVA) adhesive. And/or, a material of the second adhesive layer 60 may include a polyvinyl butyral adhesive, a transparent optical adhesive, or an ethylene vinyl acetate copolymer adhesive.

For example, the materials of the first adhesive layer 50 and the second adhesive layer 60 each include the PVB adhesive; or, the material of the first adhesive layer 50 includes the PVB adhesive, and the material of the second adhesive layer 60 includes the transparent optical adhesive; or, the material of the first adhesive layer 50 includes the PVB adhesive, and the material of the second adhesive layer 60 includes the EVA adhesive.

For example, the materials of the first adhesive layer 50 and the second adhesive layer 60 each include the transparent optical adhesive; or, the material of the first adhesive layer 50 includes the transparent optical adhesive, and the material of the second adhesive layer 60 includes the PVB adhesive; or, the material of the first adhesive layer 50 includes the transparent optical adhesive, and the material of the second adhesive layer 60 includes the EVA adhesive.

For example, the materials of the first adhesive layer 50 and the second adhesive layer 60 each include the EVA adhesive; or, the material of the first adhesive layer 50 includes the EVA adhesive, and the material of the second adhesive layer 60 includes the PVB adhesive; or, the material of the first adhesive layer 50 includes the EVA adhesive, and the material of the second adhesive layer 60 includes the transparent optical adhesive.

In some embodiments, as shown in FIG. 7, in a case where the material of the first adhesive layer 50 includes the PVB adhesive, the orthographic projection of the first adhesive layer 50 on the reference plane approximately coincides with the orthographic projection of the light adjustment module 30 on the reference plane.

In a case where the light adjustment device 100 further includes the sealant 90, the sealant 90 further surrounds the light adjustment module 30 and the first adhesive layer 50, and is connected to a circumferential sidewall of the light adjustment module 30 and a circumferential sidewall of the first adhesive layer 50.

In some embodiments, as shown in FIG. 7, in a case where the material of the second adhesive layer 60 includes the PVB adhesive, the orthographic projection of the second adhesive layer 60 on the reference plane approximately coincides with the orthographic projection of the light adjustment module 30 on the reference plane.

In a case where the light adjustment device 100 further includes the sealant 90, the sealant 90 further surrounds the light adjustment module 30 and the second adhesive layer 60, and is connected to the circumferential sidewall of the light adjustment module 30 and a circumferential sidewall of the second adhesive layer 60.

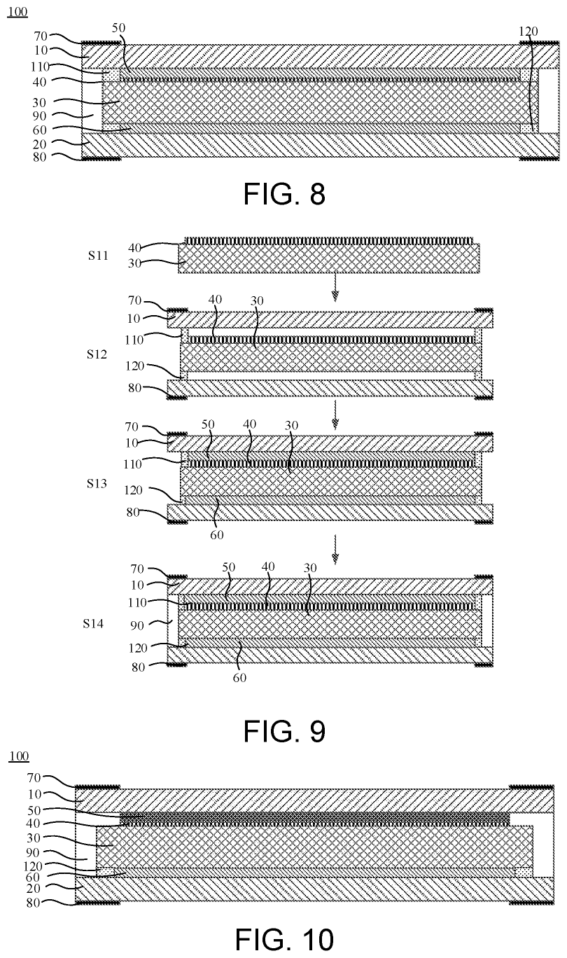

In some embodiments, as shown in FIG. 8, in a case where the material of the first adhesive layer 50 includes the transparent optical adhesive, the orthographic projection of the first adhesive layer 50 on the reference plane is located within the orthographic projection of the light adjustment module 30 on the reference plane, and has a distance from a boundary of the orthographic projection of the light adjustment module 30 on the reference plane.

The light adjustment device 100 further includes a first frame sealing adhesive 110, the first frame sealing adhesive 110 is disposed around the first adhesive layer 50 and bonded to the circumferential sidewall of the first adhesive layer 50.

In a case where the light adjustment device 100 further includes the sealant 90, the sealant 90 further surrounds the light adjustment module 30 and the first frame sealing adhesive 110, and is connected to the circumferential sidewall of the light adjustment module 30 and a surface of the first frame sealing adhesive 110 away from the first adhesive layer 50.

For example, the first frame sealing adhesive 110 may be a very high bond (VHB) tape or a room temperature vulcanized (RTV) silicone rubber adhesive.

The VHB tape includes a foam layer and viscose layers respectively located on two sides of the foam layer, and the foam layer and the viscose layers respectively located on the two sides of the foam layer are each composed of polyacrylate viscoelastic body. Since the foam layer of the VHB tape is a closed-cell structure, the risk of water vapor in the air entering the first adhesive layer 50 and the second adhesive layer 60 may be reduced, so as to improve the service life of the first adhesive layer 50 and the second adhesive layer 60. The VHB tape may bond different types of materials, and the risk of deformation and stress caused by different thermal expansion coefficients is reduced.

The RTV adhesive is prepared by compounding silicone rubber, cross-linking agent, filler, etc., and may bond metal and non-metal materials. The RTV adhesive may adopt a moisture curing. The moisture curing refers to that the RTV adhesive reacts chemically with water molecules in the air to form a stable chemical structure. In a case where the material of the first frame sealing adhesive 110 includes the RTV adhesive, there is a need to use a special dispensing equipment such that a width of the first frame sealing adhesive 110 is in a range of 5 mm to 10 mm, and a width accuracy of the first frame sealing adhesive 110 is ±0.5 mm. For example, the width of the first frame sealing adhesive 110 is 5 mm, 7.5 mm or 10 mm, which will not be described in details in the embodiments of the present disclosure.

In some embodiments, as shown in FIG. 8, in a case where the material of the second adhesive layer 60 includes the transparent optical adhesive, the orthographic projection of the second adhesive layer 60 on the reference plane is located within the orthographic projection of the light adjustment module 30 on the reference plane, and has a distance from the boundary of the orthographic projection of the light adjustment module 30 on the reference plane.

The light adjustment device 100 further includes a second frame sealing adhesive 120. The second frame sealing adhesive 120 is disposed around the second adhesive layer 60, and is bonded to the circumferential sidewall of the second adhesive layer 60. A material of the second frame sealing adhesive 120 may be the same as the material of the first frame sealing adhesive 110.

In a case where the light adjustment device 100 further includes the sealant 90, the sealant 90 further surrounds the light adjustment module 30 and the second frame sealing adhesive 120, and is connected to the circumferential sidewall of the light adjustment module 30 and a surface of the second frame sealing adhesive 120 away from the second adhesive layer 60.

It should be understood that the embodiments of the present disclosure are not limited thereto. In some possible situations, there may be any combination of the above-mentioned multiple embodiments.

In some embodiments, as shown in FIG. 7, the ultraviolet light blocking layer 40 is located on the surface of the light adjustment module 30 proximate to the first substrate 10. The material of the ultraviolet light blocking layer 40 may be the ultraviolet blocking optical adhesive, or cerium dioxide and titanium dioxide. The boundary of the orthographic projection of the ultraviolet light blocking layer 40 on the reference plane approximately coincides with the inner boundary of the orthographic projection of the first light-shielding layer 70 on the reference plane. The orthographic projection of the ultraviolet light blocking layer 40 on the reference plane is located within the orthographic projection of the light adjustment module 30 on the reference plane, and has a distance from the boundary of the orthographic projection of the light adjustment module 30 on the reference plane. The materials of the first adhesive layer 50 and the second adhesive layer 60 each include the PVB adhesive. The first adhesive layer 50 is located between the ultraviolet light blocking layer 40 and the first substrate 10, and the orthographic projection of the first adhesive layer 50 on the reference plane approximately coincides with the orthographic projection of the ultraviolet light blocking layer 40 on the reference plane. The orthographic projection of the second adhesive layer 60 on the reference plane approximately coincides with the orthographic projection of the light adjustment module 30 on the reference plane. The orthographic projection of the first substrate 10 on the reference plane approximately coincides with the orthographic projection of the second substrate 20 on the reference plane. The sealant 90 is disposed around the light adjustment module 30, the ultraviolet light blocking layer 40, the first adhesive layer 50 and the second adhesive layer 60, and part of the sealant 90 is located between the light adjustment module 30 and the first substrate 10.

In some embodiments, as shown in FIG. 8, the ultraviolet light blocking layer 40 is located on the surface of the light adjustment module 30 proximate to the first substrate 10. The material of the ultraviolet light blocking layer 40 may be the ultraviolet blocking optical adhesive, or cerium dioxide and titanium dioxide. The boundary of the orthographic projection of the ultraviolet light blocking layer 40 on the reference plane approximately coincides with the inner boundary of the orthographic projection of the first light-shielding layer 70 on the reference plane. The orthographic projection of the ultraviolet light blocking layer 40 on the reference plane is located within the orthographic projection of the light adjustment module 30 on the reference plane, and has a distance from the boundary of the orthographic projection of the light adjustment module 30 on the reference plane. The materials of the first adhesive layer 50 and the second adhesive layer 60 each include the transparent optical adhesive. The first adhesive layer 50 is located between the ultraviolet light blocking layer 40 and the first substrate 10. The orthographic projection of the first adhesive layer 50 on the reference surface is located within the orthographic projection of the ultraviolet light blocking layer 40 on the reference plane, and has a distance from the boundary of the orthographic projection of the ultraviolet light blocking layer 40 on the reference plane. The orthographic projection of the second adhesive layer 60 on the reference plane is located within the orthographic projection of the light adjustment module 30 on the reference plane, and has a distance from the boundary of the orthographic projection of the light adjustment module 30 on the reference plane. The light adjustment device 100 further includes the first frame sealing adhesive 110 and the second frame sealing adhesive 120. The first frame sealing adhesive 110 is used to adhere the light adjustment module 30 and the first substrate 10. The first frame sealing adhesive 110 is disposed around the first adhesive layer 50 and the ultraviolet light blocking layer 40, and is bonded to the circumferential sidewall of the first adhesive layer 50 and the circumferential sidewall of the ultraviolet light blocking layer 40. The second frame sealing adhesive 120 is disposed around the second adhesive layer 60, and is bonded to the circumferential sidewall of the second adhesive layer 60. The sealant 90 is disposed around the first frame sealing adhesive 110 and the second frame sealing adhesive 120.

The embodiments of the present disclosure further provide a manufacturing method of the light adjustment device 100 as shown in FIG. 8. As shown in FIG. 9, the manufacturing method includes S11 to S14.

In S11, the ultraviolet light blocking layer 40 is formed on the surface of the light adjustment module 30 proximate to the first substrate 10.

The ultraviolet light blocking layer 40 is formed on the surface of the light adjustment module 30 proximate to the first substrate 10. The orthographic projection of the ultraviolet light blocking layer 40 on the reference plane is located within the orthographic projection of the light adjustment module 30 on the reference plane, and has a distance from the boundary of the orthographic projection of the light adjustment module 30 on the reference plane.

In a case where the material of the ultraviolet light blocking layer 40 includes the ultraviolet blocking optical adhesive, a vacuum bonding process may be used to form the ultraviolet light blocking layer 40 on the surface of the light adjustment module 30 proximate to the first substrate 10.

In a case where the material of the ultraviolet light blocking layer 40 includes cerium dioxide and titanium dioxide, a sol-gel method or a magnetron sputtering method may be used to form the ultraviolet light blocking layer 40 on the surface of the light adjustment module 30 proximate to the first substrate 10.

In S12, the first substrate 10 and the second substrate 20 are bonded to the light adjustment module 30.

For example, S12 includes S121 and S122.

In S121, the first frame sealing adhesive 110 bonds the first substrate 10 to the light adjustment module 30.

For example, ink is applied on an edge of a surface of the first substrate 10 in advance to form the first light-shielding layer 70. The first frame sealing adhesive 110 is bonded to three edges of the surface of the light adjustment module 30 where the ultraviolet light blocking layer 40 is formed, the first frame sealing adhesive 110 is bonded to three circumferential sidewalls of the ultraviolet light blocking layer 40, and the first frame sealing adhesive 110 surrounds the ultraviolet light blocking layer 40. Next, the light adjustment module 30 is bonded to a surface of the first substrate 10 where the first light-shielding layer 70 is not formed using the first frame sealing adhesive 110, so as to form a first accommodating groove with a first opening. The inner boundary of the orthographic projection of the first light-shielding layer 70 on the reference plane approximately coincides with the boundary of the orthographic projection of the ultraviolet light blocking layer 40 on the reference plane.

In S122, the second frame sealing adhesive 120 bonds the second substrate 20 to the light adjustment module 30.

For example, ink is applied on an edge of a surface of the second substrate 20 in advance to form the second light-shielding layer 80. The second frame sealing adhesive 120 is bonded to three edges of a surface of the light adjustment module 30 where the ultraviolet light blocking layer 40 is not formed, and then the light adjustment module 30 is bonded to a surface of the second substrate 20 where the second light-shielding layer 80 is not formed by using the second frame sealing adhesive 120, so as to form a second accommodating groove with a second opening.

It can be understood that the order of steps S11 and S121 and step S122 may be exchanged. That is, S11, S121, and S122 may be performed in sequence; or S122 may be performed first, and then S11 and S121 may be performed.

In S13, the first adhesive layer 50 and the second adhesive layer 60 are formed.

For example, S13 includes S131 and S132.

In S131, the first adhesive layer 50 is formed between the first substrate 10 and the light adjustment module 30.

The first adhesive layer 50 is formed by pouring the transparent optical adhesive into the first accommodating groove through the first opening, and then the first frame sealing adhesive 110 is provided at a position of the first opening, and the first opening is sealed with the first frame sealing adhesive 110.

In S132, the second adhesive layer 60 is formed between the second substrate 20 and the light adjustment module 30.

The second adhesive layer 60 is formed by pouring the transparent optical adhesive into the second accommodating groove through the second opening, and then the second frame sealing adhesive 120 is provided at a position of the second opening, and the second opening is sealed with the second frame sealing adhesive 120.

It can be understood that the order of step S131 and step S132 may be interchanged. That is, S131 and S132 may be performed in sequence; or, S132 may be performed first, and then S131 may be performed; or, S131 and S132 may be performed simultaneously.

In S14, the sealant 90 is filled between the first substrate 10 and the second substrate 20.

The sealant 90 surrounds the light adjustment module 30, the first frame sealing adhesive 110, and the second frame sealing adhesive 120, is connected to the circumferential sidewall of the light adjustment module 30 and the surface of the first frame sealing adhesive 110 away from the first adhesive layer 50, and is connected to the surface of the second frame sealing adhesive 120 away from the second adhesive layer 60.

In some embodiments, as shown in FIG. 10, the ultraviolet light blocking layer 40 is located on the surface of the light adjustment module 30 proximate to the first substrate 10. The material of the ultraviolet light blocking layer 40 may be the ultraviolet blocking optical adhesive, or cerium dioxide and titanium dioxide. The boundary of the orthographic projection of the ultraviolet light blocking layer 40 on the reference plane approximately coincides with the inner boundary of the orthographic projection of the first light-shielding layer 70 on the reference plane. The orthographic projection of the ultraviolet light blocking layer 40 on the reference plane is located within the orthographic projection of the light adjustment module 30 on the reference plane, and has a distance from the boundary of the orthographic projection of the light adjustment module 30 on the reference plane. The material of the first adhesive layer 50 includes the PVB adhesive, and the material of the second adhesive layer 60 includes the transparent optical adhesive. The first adhesive layer 50 is located between the ultraviolet light blocking layer 40 and the first substrate 10, and the orthographic projection of the first adhesive layer 50 on the reference plane approximately coincides with the orthographic projection of the ultraviolet light blocking layer 40 on the reference plane. The orthographic projection of the second adhesive layer 60 on the reference plane is located within the orthographic projection of the light adjustment module 30 on the reference plane, and has a distance from the boundary of the orthographic projection of the light adjustment module 30 on the reference plane. The second frame sealing adhesive 120 is disposed around the second adhesive layer 60, and is bonded to the circumferential sidewall of the second adhesive layer 60. The sealant 90 is disposed around the light adjustment module 30, the ultraviolet light blocking layer 40, the first adhesive layer 50 and the second frame sealing adhesive 120, and is partially located between the light adjustment module 30 and the first substrate 10.

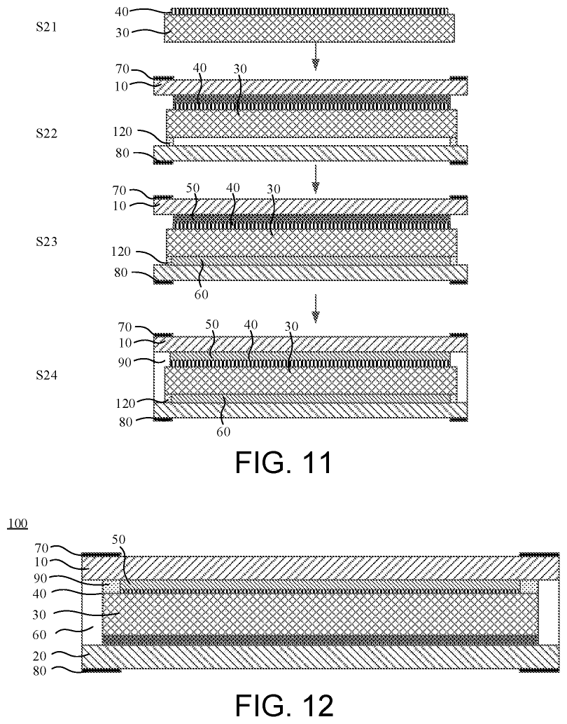

The embodiments of the present disclosure further provide a manufacturing method of the light adjustment device 100 as shown in FIG. 10. As shown in FIG. 11, the manufacturing method includes S21 to S24.

In S21, the ultraviolet light blocking layer 40 is formed on the surface of the light adjustment module 30 proximate to the first substrate 10.

The ultraviolet light blocking layer 40 is formed on the surface of the light adjustment module 30 proximate to the first substrate 10. The orthographic projection of the ultraviolet light blocking layer 40 on the reference plane is located within the orthographic projection of the light adjustment module 30 on the reference plane, and has a distance from the boundary of the orthographic projection of the light adjustment module 30 on the reference plane.

In a case where the material of the ultraviolet light blocking layer 40 includes the ultraviolet blocking optical adhesive, a vacuum bonding process may be used to form the ultraviolet light blocking layer 40 on the surface of the light adjustment module 30 proximate to the first substrate 10.

In a case where the material of the ultraviolet light blocking layer 40 includes cerium dioxide and titanium dioxide, a sol-gel method or a magnetron sputtering method may be used to form the ultraviolet light blocking layer 40 on the surface of the light adjustment module 30 proximate to the first substrate 10.

In S22, the first substrate 10 and the second substrate 20 are bonded to the light adjustment module 30.

For example, S22 includes S221 and S222.

In S221, the first adhesive layer 50 bonds the first substrate 10 to the light adjustment module 30.

For example, ink is applied on an edge of a surface of the first substrate 10 in advance to form the first light-shielding layer 70. A surface of the ultraviolet light blocking layer 40 is coated with the PVB adhesive to form the first adhesive layer 50, and the PVB adhesive covers the surface of the ultraviolet light blocking layer 40. Then, the light adjustment module 30 is bonded to a surface of the first substrate 10 where the first light-shielding layer 70 is not formed by using the first adhesive layer 50. The inner boundary of the orthographic projection of the first light-shielding layer 70 on the reference plane approximately coincides with the boundary of the orthographic projection of the ultraviolet light blocking layer 40 on the reference plane.

In S222, the second frame sealing adhesive 120 bonds the second substrate 20 to the light adjustment module 30.

For example, ink is applied on an edge of a surface of the second substrate 20 in advance to form the second light-shielding layer 80. The second frame sealing adhesive 120 is bonded to three edges of a surface of the light adjustment module 30 where the ultraviolet light blocking layer 40 is not formed, and then the light adjustment module 30 is bonded to a surface of the second substrate 20 where the second light-shielding layer 80 is not formed by using the second frame sealing adhesive 120, so as to form a second accommodating groove with a second opening.

It can be understood that the order of steps S21 and S221, and step S222 may be exchanged. That is, S21, S221 and S222 may be performed in sequence; or S222 may be performed first, and then S21 and S221 may be performed.

In S23, the second adhesive layer 60 is formed between the second substrate 20 and the light adjustment module 30.

The second adhesive layer 60 is formed by pouring the transparent optical adhesive into the second accommodating groove through the second opening, and then the second frame sealing adhesive 120 is provided at a position of the second opening, and the second opening is sealed with the second frame sealing adhesive 120.

In S24, the sealant 90 is filled between the first substrate 10 and the second substrate 20.

The sealant 90 surrounds the light adjustment module 30, the ultraviolet light blocking layer 40, the first adhesive layer 50 and the second frame sealing adhesive 120, and is connected to the circumferential sidewall of the light adjustment module 30, the circumferential sidewall of the ultraviolet light blocking layer 40, the circumferential sidewall of the first adhesive layer 50 and the surface of the second frame sealing adhesive 120 away from the second adhesive layer 60; and the sealant 90 is partially located between the light adjustment module 30 and the first substrate 10.

In some embodiments, as shown in FIG. 12, the ultraviolet light blocking layer 40 is located on the surface of the light adjustment module 30 proximate to the first substrate 10. The material of the ultraviolet light blocking layer 40 may be the ultraviolet blocking optical adhesive, or cerium dioxide and titanium dioxide. The boundary of the orthographic projection of the ultraviolet light blocking layer 40 on the reference plane approximately coincides with the inner boundary of the orthographic projection of the first light-shielding layer 70 on the reference plane. The orthographic projection of the ultraviolet light blocking layer 40 on the reference plane is located within the orthographic projection of the light adjustment module 30 on the reference plane, and has a distance from the boundary of the orthographic projection of the light adjustment module 30 on the reference plane. The material of the first adhesive layer 50 includes the transparent optical adhesive, and the material of the second adhesive layer 60 includes the PVB adhesive. The first adhesive layer 50 is located between the ultraviolet light blocking layer 40 and the first substrate 10, and the orthographic projection of the first adhesive layer 50 on the reference plane approximately coincides with the orthographic projection of the ultraviolet light blocking layer 40 on the reference plane. The orthographic projection of the second adhesive layer 60 on the reference plane approximately coincides with the orthographic projection of the light adjustment module 30 on the reference plane. The first frame sealing adhesive 110 is used to adhere the light adjustment module 30 and the first substrate 10. The first frame sealing adhesive 110 is disposed around the first adhesive layer 50 and the ultraviolet light blocking layer 40, and is bonded to the circumferential sidewall of the first adhesive layer 50 and the circumferential sidewall of the ultraviolet light blocking layer 40. The sealant 90 is disposed around the first frame sealing adhesive 110 and the second adhesive layer 60.

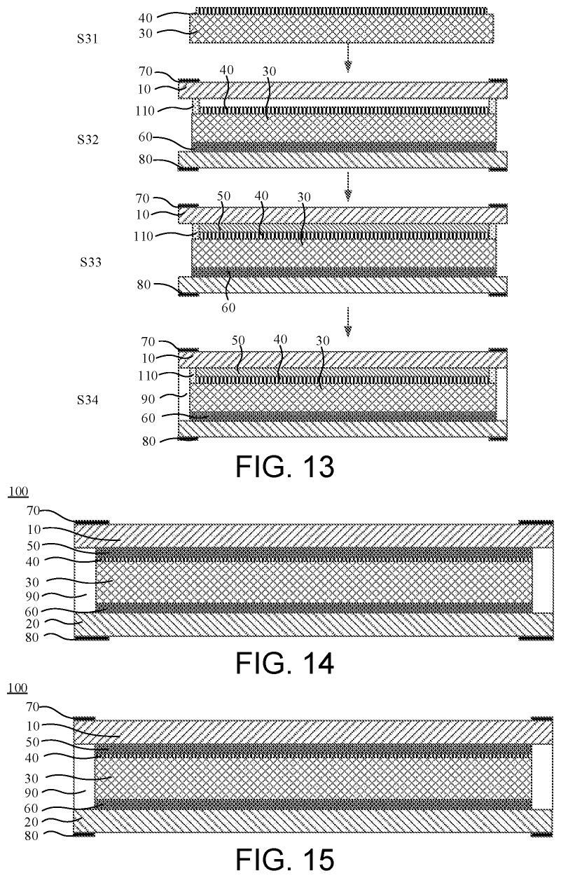

The embodiments of the present disclosure further provide a manufacturing method of the light adjustment device 100 as shown in FIG. 12. As shown in FIG. 13, the manufacturing method includes S31 to S34.

In S31, the ultraviolet light blocking layer 40 is formed on the surface of the light adjustment module 30 proximate to the first substrate 10.

The ultraviolet light blocking layer 40 is formed on the surface of the light adjustment module 30 proximate to the first substrate 10. The orthographic projection of the ultraviolet light blocking layer 40 on the reference plane is located within the orthographic projection of the light adjustment module 30 on the reference plane, and has a distance from the boundary of the orthographic projection of the light adjustment module 30 on the reference plane.

In a case where the material of the ultraviolet light blocking layer 40 includes the ultraviolet blocking optical adhesive, a vacuum bonding process may be used to form the ultraviolet light blocking layer 40 on the surface of the light adjustment module 30 proximate to the first substrate 10.

In a case where the material of the ultraviolet light blocking layer 40 includes cerium dioxide and titanium dioxide, a sol-gel method or a magnetron sputtering method may be used to form the ultraviolet light blocking layer 40 on the surface of the light adjustment module 30 proximate to the first substrate 10.

In S32, the first substrate 10 and the second substrate 20 are bonded to the light adjustment module 30.

For example, S32 includes S321 and S322.

In S321, the first frame sealing adhesive 110 bonds the first substrate 10 to the light adjustment module 30.

For example, ink is applied on an edge of a surface of the first substrate 10 in advance to form the first light-shielding layer 70. The first frame sealing adhesive 110 is bonded to three edges of the surface of the light adjustment module 30 where the ultraviolet light blocking layer 40 is formed, the first frame sealing adhesive 110 is bonded to three circumferential sidewalls of the ultraviolet light blocking layer 40, and the first frame sealing adhesive 110 surrounds the ultraviolet light blocking layer 40. Next, the light adjustment module 30 is bonded to a surface of the first substrate 10 where the first light-shielding layer 70 is not formed using the first frame sealing adhesive 110, so as to form a first accommodating groove with a first opening. The inner boundary of the orthographic projection of the first light-shielding layer 70 on the reference plane approximately coincides with the orthographic projection of the ultraviolet light blocking layer 40 on the reference plane.

In S322, the second adhesive layer 60 bonds the second substrate 20 to the light adjustment module 30.

For example, a surface of the light adjustment module 30 where the ultraviolet light blocking layer 40 is not formed is coated with the PVB adhesive to form the second adhesive layer 60, and the PVB adhesive covers the surface of the light adjustment module 30. The second adhesive layer 60 bonds the light adjustment module 30 to a surface of the second substrate 20 where the first light-shielding layer 70 is not formed.

It can be understood that the order of steps S31 and S321, and step S322 may be exchanged. That is, S31, S321 and S322 may be performed in sequence, or S322 may be performed first, and then S31 and S321 may be performed.

In S33, the first adhesive layer 50 is formed between the first substrate 10 and the light adjustment module 30.

The first adhesive layer 50 is formed by pouring the transparent optical adhesive into the first accommodating groove through the first opening, and then the first frame sealing adhesive 110 is provided at a position of the first opening, and the first opening is sealed with the first frame sealing adhesive 110.

In S34, the sealant 90 is filled between the first substrate 10 and the second substrate 20.

The sealant 90 surrounds the light adjustment module 30, the first frame sealing adhesive 110, and the second frame sealing adhesive 120, and is connected to the circumferential sidewall of the light adjustment module 30, the surface of the first frame sealing adhesive 110 away from the first adhesive layer 50, and the surface of the second frame sealing adhesive 120 away from the second adhesive layer 60.

In some embodiments, as shown in FIGS. 14 and 15, the ultraviolet light blocking layer 40 is located on the surface of the light adjustment module 30 proximate to the first substrate 10. The material of the ultraviolet light blocking layer 40 may be the ultraviolet blocking optical adhesive, or cerium dioxide and titanium dioxide. The orthographic projection of the ultraviolet light blocking layer 40 on the reference plane approximately coincides with the orthographic projection of the light adjustment module 30 on the reference plane. The materials of the first adhesive layer 50 and the second adhesive layer 60 each include the PVB adhesive. The first adhesive layer 50 is located between the ultraviolet light blocking layer 40 and the first substrate 10; and the orthographic projection of the ultraviolet light blocking layer 40 on the reference plane is located within the orthographic projection of the first substrate 10 on the reference plane, and has a distance from the boundary of the orthographic projection of the first substrate 10 on the reference plane. The orthographic projection of the first adhesive layer 50 on the reference plane approximately coincides with the orthographic projection of the ultraviolet light blocking layer 40 on the reference plane. The orthographic projection of the second adhesive layer 60 on the reference plane approximately coincides with the orthographic projection of the light adjustment module 30 on the reference plane. The sealant 90 is disposed around the light adjustment module 30, the ultraviolet light blocking layer 40, the first adhesive layer 50, and the second adhesive layer 60. In a case where the light adjustment device 100 further includes the first light-shielding layer 70, as shown in FIG. 14, the inner boundary of the orthographic projection of the first light-shielding layer 70 on the reference plane is located within the orthographic projection of the ultraviolet light blocking layer 40 on the reference plane; or, as shown in FIG. 15, the inner boundary of the orthographic projection of the first light-shielding layer 70 on the reference plane coincides with the boundary of the orthographic projection of the ultraviolet light blocking layer 40 on the reference plane.

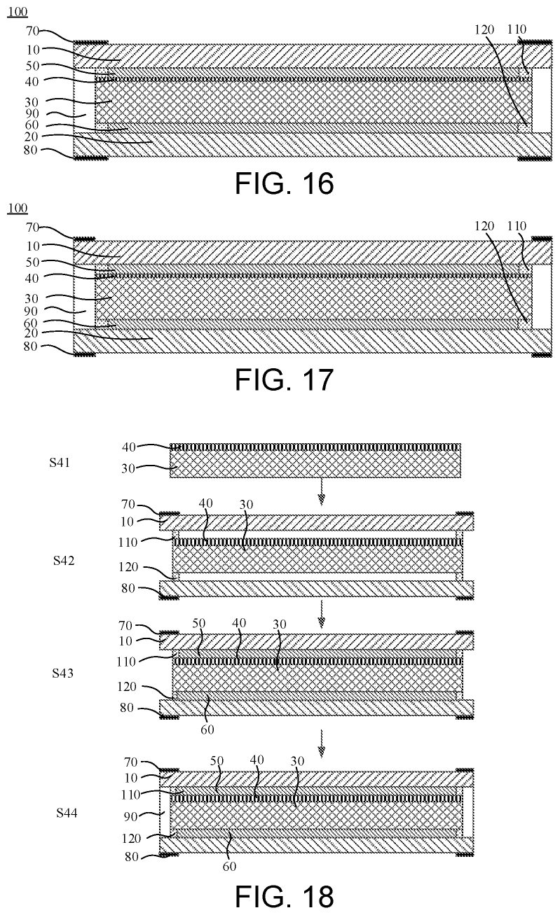

In some embodiments, as shown in FIGS. 16 and 17, the ultraviolet light blocking layer 40 is located on the surface of the light adjustment module 30 proximate to the first substrate 10. The material of the ultraviolet light blocking layer 40 may be the ultraviolet blocking optical adhesive, or cerium dioxide and titanium dioxide. The orthographic projection of the ultraviolet light blocking layer 40 on the reference plane approximately coincides with the orthographic projection of the light adjustment module 30 on the reference plane. The orthographic projection of the ultraviolet light blocking layer 40 on the reference plane is located within the orthographic projection of the first substrate 10 on the reference plane, and has a distance from the boundary of the orthographic projection of the first substrate 10 on the reference plane. The materials of the first adhesive layer 50 and the second adhesive layer 60 each include the transparent optical adhesive. The first adhesive layer 50 is located between the ultraviolet light blocking layer 40 and the first substrate 10. The orthographic projection of the first adhesive layer 50 on the reference plane is located within the orthographic projection of the ultraviolet light blocking layer 40 on the reference plane, and has a distance from the boundary of the orthographic projection of the ultraviolet light blocking layer 40 on the reference plane. The first frame sealing adhesive 110 is used to adhere the ultraviolet light blocking layer 40 and the first substrate 10, and the first frame sealing adhesive 110 is disposed around the first adhesive layer 50 and bonded to the circumferential sidewall of the first adhesive layer 50. The orthographic projection of the second adhesive layer 60 on the reference plane is located within the orthographic projection of the light adjustment module 30 on the reference plane, and has a distance from the boundary of the orthographic projection of the light adjustment module 30 on the reference plane. The second frame sealing adhesive 120 is disposed around the second adhesive layer 60, and is bonded to the circumferential sidewall of the second adhesive layer 60. The sealant 90 is disposed around the light adjustment module 30, the ultraviolet light blocking layer 40, the first frame sealing adhesive 110 and the second frame sealing adhesive 120. In a case where the light adjustment device 100 further includes the first light-shielding layer 70, as shown in FIG. 16, the inner boundary of the orthographic projection of the first light-shielding layer 70 on the reference plane is located within the orthographic projection of the ultraviolet light blocking layer 40 on the reference plane, or, as shown in FIG. 17, the inner boundary of the orthographic projection of the first light-shielding layer 70 on the reference plane coincides with the boundary of the orthographic projection of the ultraviolet light blocking layer 40 on the reference plane.

The embodiments of the present disclosure further provide a manufacturing method of the light adjustment device 100 as shown in FIG. 16. As shown in FIG. 18, the manufacturing method includes S41 to S44.

In S41, the ultraviolet light blocking layer 40 is formed on the surface of the light adjustment module 30 proximate to the first substrate 10.

The ultraviolet light blocking layer 40 is formed on the surface of the light adjustment module 30 proximate to the first substrate 10. The orthographic projection of the ultraviolet light blocking layer 40 on the reference plane approximately coincides with the orthographic projection of the light adjustment module 30 on the reference plane.

In a case where the material of the ultraviolet light blocking layer 40 includes the ultraviolet blocking optical adhesive, a vacuum bonding process may be used to form the ultraviolet light blocking layer 40 on the surface of the light adjustment module 30 proximate to the first substrate 10, and the ultraviolet blocking optical adhesive covers the surface of the light adjustment module 30.

In a case where the material of the ultraviolet light blocking layer 40 includes cerium dioxide and titanium dioxide, a sol-gel method or a magnetron sputtering method may be used to form the ultraviolet light blocking layer 40 on the surface of the light adjustment module 30 proximate to the first substrate 10, and cerium dioxide and titanium dioxide cover the surface of the light adjustment module 30.

In S42, the first substrate 10 and the second substrate 20 are bonded to the light adjustment module 30.

For example, S42 includes S421 and S422.

In S421, the first frame sealing adhesive 110 bonds the first substrate 10 to the light adjustment module 30.

For example, in a case where the light adjustment device 100 includes the first light-shielding layer 70, ink needs to be applied on an edge of a surface of the first substrate 10 to form the first light-shielding layer 70 in advance. The first frame sealing adhesive 110 is bonded to three edges of a surface of the ultraviolet light blocking layer 40. Then, the ultraviolet light blocking layer 40 is bonded to a surface of the first substrate 10 where the first light-shielding layer 70 is not formed by using the first frame sealing adhesive 110, so as to form a first accommodating groove with a first opening. The inner boundary of the orthographic projection of the first light-shielding layer 70 on the reference plane is located within the orthographic projection of the ultraviolet light blocking layer 40 on the reference plane, or coincides with the boundary of the orthographic projection of the ultraviolet light blocking layer 40 on the reference plane.

For example, in a case where the light adjustment device 100 does not include the first light-shielding layer 70, the first frame sealing adhesive 110 is bonded to the three edges of the surface of the ultraviolet light blocking layer 40, and then the light adjustment module 30 is bonded to the surface of the first substrate 10 by using the first frame sealing adhesive 110, so as to form the first accommodating groove with the first opening.

In S422, the second frame sealing adhesive 120 bonds the second substrate 20 to the light adjustment module 30.

For example, in a case where the light adjustment device 100 includes the second light-shielding layer 80, ink needs to be applied on an edge of a surface of the second substrate 20 to form the second light-shielding layer 80 in advance. The second frame sealing adhesive 120 is bonded to three edges of a surface of the light adjustment module 30 where the ultraviolet light blocking layer 40 is not formed, and the light adjustment module 30 is bonded to a surface of the second substrate 20 where the second light-shielding layer 80 is not formed by using the second frame sealing adhesive 120, so as to form a second accommodating groove with a second opening.

For example, in a case where the light adjustment device 100 does not include the second light-shielding layer 80, the second frame sealing adhesive 120 is bonded to the three edges of the surface of the light adjustment module 30 where the ultraviolet light blocking layer 40 is not formed, and then the light adjustment module 30 is bonded to the surface of the second substrate 20 by using the second frame sealing adhesive 120, so as to form the second accommodating groove with the second opening.

It can be understood that the order of steps S41 and S421, and step S422 may be exchanged. That is, S41, S421 and S422 may be performed in sequence, or S422 may be performed first, and then S41 and S421 may be performed.

In S43, the first adhesive layer 50 and the second adhesive layer 60 are formed.

For example, S43 includes S431 and S432.

In S431, the first adhesive layer 50 is formed between the first substrate 10 and the light adjustment module 30.

The first adhesive layer 50 is formed by pouring the transparent optical adhesive into the first accommodating groove through the first opening, and then the first frame sealing adhesive 110 is provided at a position of the first opening, and the first opening is sealed with the first frame sealing adhesive 110.

In S432, the second adhesive layer 60 is formed between the second substrate 20 and the light adjustment module 30, and then the second frame sealing adhesive 120 is provided at a position of the second opening, and the second opening is sealed with the second frame sealing adhesive 120.

The second adhesive layer 60 is formed by pouring the transparent optical adhesive into the second accommodating groove through the second opening.

It can be understood that the order of steps S431 and S432 may be interchanged. That is, S431 and S432 may be performed in sequence; or S432 may be performed first, and then S431 may be performed; or S431 and S432 may be performed simultaneously.

In S44, the sealant 90 is filled between the first substrate 10 and the second substrate 20.

The sealant 90 surrounds the light adjustment module 30, the ultraviolet light blocking layer 40, the first frame sealing adhesive 110, and the second frame sealing adhesive 120, and is connected to the circumferential sidewall of the light adjustment module 30, the circumferential sidewall of the ultraviolet light blocking layer 40, the surface of the first frame sealing adhesive 110 away from the first adhesive layer 50, and the surface of the second frame sealing adhesive 120 away from the second adhesive layer 60.

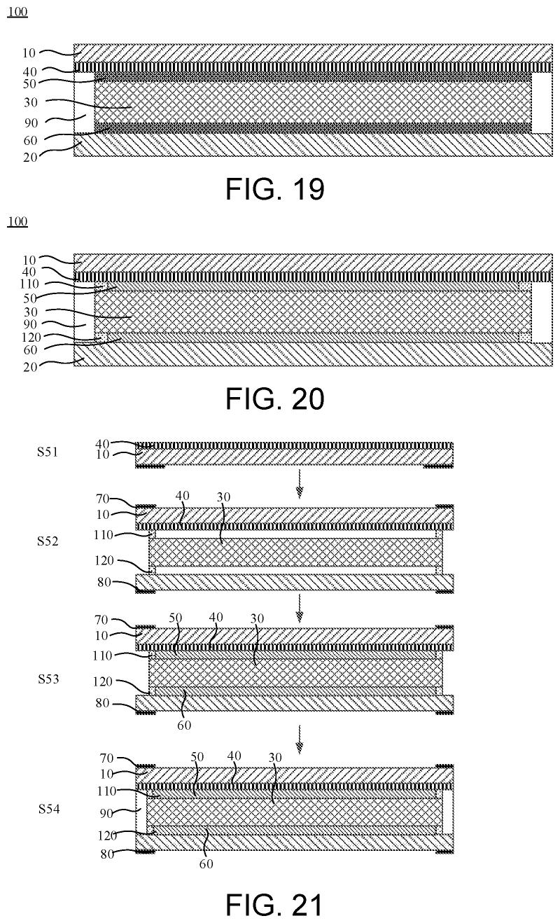

In some embodiments, as shown in FIG. 19, the ultraviolet light blocking layer 40 is located on the surface of the first substrate 10 proximate to the light adjustment module 30. The material of the ultraviolet light blocking layer 40 may be the ultraviolet blocking optical adhesive, or cerium dioxide and titanium dioxide. The orthographic projection of the ultraviolet light blocking layer 40 on the reference plane approximately coincides with the orthographic projection of the first substrate 10 on the reference plane. The orthographic projection of the light adjustment module 30 on the reference plane is located within the orthographic projection of the ultraviolet light blocking layer 40 on the reference plane, and has a distance from the boundary of the orthographic projection of the ultraviolet light blocking layer 40 on the reference plane. The materials of the first adhesive layer 50 and the second adhesive layer 60 each include the PVB adhesive. The first adhesive layer 50 is located between the ultraviolet light blocking layer 40 and the light adjustment module 30, and the orthographic projection of the first adhesive layer 50 on the reference plane approximately coincides with the orthographic projection of the light adjustment module 30 on the reference plane. The orthographic projection of the second adhesive layer 60 on the reference plane approximately coincides with the orthographic projection of the light adjustment module 30 on the reference plane, and the sealant 90 is disposed around the light adjustment module 30, the first adhesive layer 50 and the second adhesive Layer 60.

In some embodiments, as shown in FIG. 20, the ultraviolet light blocking layer 40 is located on the surface of the first substrate 10 proximate to the light adjustment module 30. The material of the ultraviolet light blocking layer 40 may be the ultraviolet blocking optical adhesive, or cerium dioxide and titanium dioxide. The orthographic projection of the ultraviolet light blocking layer 40 on the reference plane approximately coincides with the orthographic projection of the first substrate 10 on the reference plane. The orthographic projection of the light adjustment module 30 on the reference plane is located within the orthographic projection of the ultraviolet light blocking layer 40 on the reference plane, and has a distance from the boundary of the orthographic projection of the ultraviolet light blocking layer 40 on the reference plane. The materials of the first adhesive layer 50 and the second adhesive layer 60 each include the transparent optical adhesive. The first adhesive layer 50 is located between the ultraviolet light blocking layer 40 and the light adjustment module 30. The orthographic projection of the first adhesive layer 50 on the reference plane is located within the orthographic projection of the light adjustment module 30 on the reference plane, and has a distance from the boundary of the orthographic projection of the light adjustment module 30 on the reference plane. The orthographic projection of the second adhesive layer 60 on the reference plane is located within the orthographic projection of the light adjustment module 30 on the reference plane, and has a distance from the boundary of the orthographic projection of the light adjustment module 30 on the reference plane. The first frame sealing adhesive 110 is used to adhere the light adjustment module 30 and the ultraviolet light blocking layer 40. The first frame sealing adhesive 110 is disposed around the first adhesive layer 50, and is bonded to the circumferential sidewall of the first adhesive layer 50. The second frame sealing adhesive 120 is used to adhere the light adjustment module 30 and the second substrate 20. The second frame sealing adhesive 120 is disposed around the second adhesive layer 60, and is bonded to the circumferential sidewall of the second adhesive layer 60. The sealant 90 is disposed around the light adjustment module 30, the first frame sealing adhesive 110 and the second frame sealing adhesive 120, and is connected to the circumferential sidewall of the light adjustment module 30, the surface of the first frame sealing adhesive 110 away from the first adhesive layer 50, and the surface of the second frame sealing adhesive 120 away from the second adhesive layer 60.

The embodiments of the present disclosure further provide a manufacturing method of the light adjustment device 100 as shown in FIG. 20. As shown in FIG. 21, the manufacturing method includes S51 to S54.

In S51, the ultraviolet light blocking layer 40 is formed on the surface of the first substrate 10 proximate to the light adjustment module 30.

For example, in a case where the light adjustment device 100 includes the first light-shielding layer 70, ink needs to be applied on an edge of a surface of the first substrate 10 to form the first light-shielding layer 70 in advance, and then the ultraviolet light blocking layer 40 is formed on another surface of the first substrate 10, and the orthographic projection of the ultraviolet light blocking layer 40 on the reference plane approximately coincides with the orthographic projection of the first substrate 10 on the reference plane.

For example, in a case where the light adjustment device 100 does not include the first light-shielding layer 70, the ultraviolet light blocking layer 40 may be formed on a surface of the first substrate 10, and the orthographic projection of the ultraviolet light blocking layer 40 on the reference plane approximately coincides with the orthographic projection of the first substrate 10 on the reference plane.

In a case where the material of the ultraviolet light blocking layer 40 includes the ultraviolet blocking optical adhesive, a vacuum bonding process may be used to form the ultraviolet light blocking layer 40 on the surface of the first substrate 10 proximate to the light adjustment module 30, and the ultraviolet blocking optical adhesive cover the surface of the first substrate 10.

In a case where the material of the ultraviolet light blocking layer 40 includes cerium dioxide and titanium dioxide, a sol-gel method or a magnetron sputtering method may be used to form the ultraviolet light blocking layer 40 on the surface of the first substrate 10 proximate to the light adjustment module 30, and cerium dioxide and titanium dioxide cover the surface of the light adjustment module 30.

In S52, the first substrate 10 and the second substrate 20 are bonded to the light adjustment module 30.

For example, S52 includes S521 and S522.

In S521, the first frame sealing adhesive 110 bonds the ultraviolet light blocking layer 40 to the light adjustment module 30.

For example, the first frame sealing adhesive 110 is bonded to three edges of the surface of the light adjustment module 30 proximate to the first substrate 10, and the first frame sealing adhesive 110 bonds the light adjustment module 30 to the surface of the ultraviolet blocking layer 40 to form a first accommodating groove with a first opening.

In S522, the second frame sealing adhesive 120 bonds the second substrate 20 to the light adjustment module 30.

For example, the second frame sealing adhesive 120 is bonded to the three edges of the surface of the light adjustment module 30 where the ultraviolet light blocking layer 40 is not formed, and the second frame sealing adhesive 120 bonds the light adjustment module 30 and the surface of the second substrate 20 where the second light-shielding layer 80 is not formed, so as to form the second accommodating groove with the second opening.

It can be understood that the order of steps S51 and S521, and step S522 may be exchanged. That is, S51, S521 and S522 may be performed in sequence, or S522 may be performed first, and then S51 and S521 may be performed.

In S53, the first adhesive layer 50 and the second adhesive layer 60 are formed.

For example, S53 includes S531 and S532.

In S531, the first adhesive layer 50 is formed between the ultraviolet light blocking layer 40 and the light adjustment module 30.

The first adhesive layer 50 is formed by pouring the transparent optical adhesive into the first accommodating groove through the first opening, and then the first frame sealing adhesive 110 is provided at a position of the first opening, and the first opening is sealed with the first frame sealing adhesive 110.

In S532, the second adhesive layer 60 is formed between the second substrate 20 and the light adjustment module 30.

The second adhesive layer 60 is formed by pouring the transparent optical adhesive into the second accommodating groove through the second opening, and then the second frame sealing adhesive 120 is provided at a position of the second opening, and the second opening is sealed with the second frame sealing adhesive 120.

It can be understood that the order of steps S531 and S532 may be interchanged. That is, S531 and S532 may be performed in sequence; or S532 may be performed first, and then S531 may be performed; or S531 and S532 may be performed simultaneously.

In S54, the sealant 90 is filled between the first substrate 10 and the second substrate 20.

The sealant 90 surrounds the light adjustment module 30, the first frame sealing adhesive 110, and the second frame sealing adhesive 120, and is connected to the circumferential sidewall of the light adjustment module 30, the surface of the first frame sealing adhesive 110 away from the first adhesive layer 50, and the surface of the second frame sealing adhesive 120 away from the second adhesive layer 60.

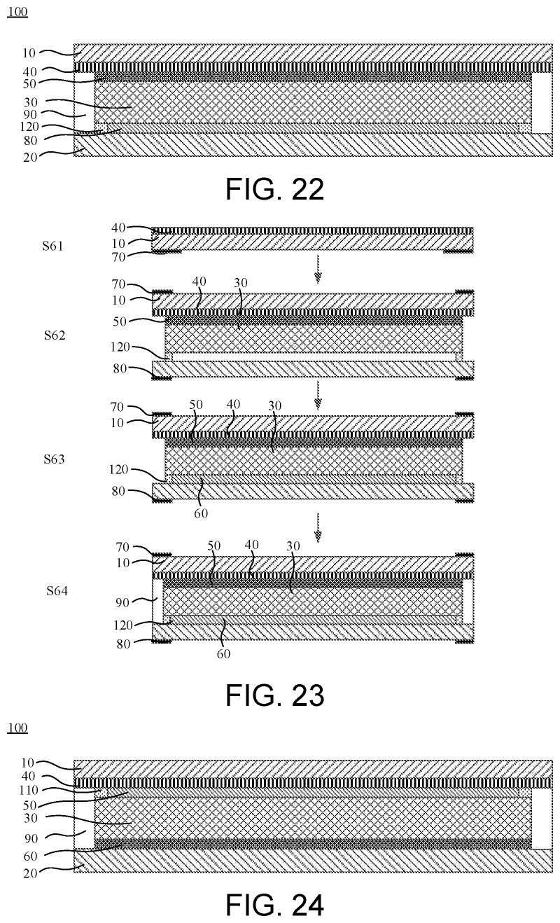

In some embodiments, as shown in FIG. 22, the ultraviolet light blocking layer 40 is located on the surface of the first substrate 10 proximate to the light adjustment module 30. The material of the ultraviolet light blocking layer 40 may be the ultraviolet blocking optical adhesive, or cerium dioxide and titanium dioxide. The orthographic projection of the ultraviolet light blocking layer 40 on the reference plane approximately coincides with the orthographic projection of the first substrate 10 on the reference plane. The orthographic projection of the light adjustment module 30 on the reference plane is located within the orthographic projection of the ultraviolet light blocking layer 40 on the reference plane, and has a distance from the boundary of the orthographic projection of the ultraviolet light blocking layer 40 on the reference plane. The material of the first adhesive layer 50 includes the PVB adhesive, and the material of the second adhesive layer 60 includes the transparent optical adhesive. The first adhesive layer 50 is located between the ultraviolet light blocking layer 40 and the light adjustment module 30, and the orthographic projection of the first adhesive layer 50 on the reference plane approximately coincides with the orthographic projection of the light adjustment module 30 on the reference plane. The orthographic projection of the second adhesive layer 60 on the reference plane is located within the orthographic projection of the light adjustment module 30 on the reference plane, and has a distance from the boundary of the orthographic projection of the light adjustment module 30 on the reference plane. The second frame sealing adhesive 120 is disposed around the second adhesive layer 60, and is bonded to the circumferential sidewall of the second adhesive layer 60. The sealant 90 is disposed around the light adjustment module 30, the first adhesive layer 50 and the second frame sealing adhesive 120, and is connected to the circumferential sidewall of the light adjustment module 30, the circumferential sidewall of the first adhesive layer 50, and the surface of the second frame sealing adhesive 120 away from the second adhesive layer 60.

The embodiments of the present disclosure further provide a manufacturing method of the light adjustment device 100 as shown in FIG. 22. As shown in FIG. 23, the manufacturing method includes S61 to S64.

In S61, the ultraviolet light blocking layer 40 is formed on the surface of the first substrate 10 proximate to the light adjustment module 30.

For example, in a case where the light adjustment device 100 includes the first light-shielding layer 70, ink needs to be applied on an edge of a surface of the first substrate 10 to form the first light-shielding layer 70 in advance, and then the ultraviolet light blocking layer 40 is formed on another surface of the first substrate 10, and the orthographic projection of the ultraviolet light blocking layer 40 on the reference plane approximately coincides with the orthographic projection of the first substrate 10 on the reference plane.

For example, in a case where the light adjustment device 100 does not include the first light-shielding layer 70, the ultraviolet light blocking layer 40 may be formed on a surface of the first substrate 10, and the orthographic projection of the ultraviolet light blocking layer 40 on the reference plane approximately coincides with the orthographic projection of the first substrate 10 on the reference plane.

In a case where the material of the ultraviolet light blocking layer 40 includes the ultraviolet blocking optical adhesive, a vacuum bonding process may be used to form the ultraviolet light blocking layer 40 on the surface of the first substrate 10 proximate to the light adjustment module 30, and the ultraviolet blocking optical adhesive cover the surface of the first substrate 10.

In a case where the material of the ultraviolet light blocking layer 40 includes cerium dioxide and titanium dioxide, a sol-gel method or a magnetron sputtering method may be used to form the ultraviolet light blocking layer 40 on the surface of the first substrate 10 proximate to the light adjustment module 30, and cerium dioxide and titanium dioxide cover the surface of the first substrate 10.

In S62, the first substrate 10 and the second substrate 20 are bonded to the light adjustment module 30.

For example, S62 includes S621 and S622.

In S621, the first adhesive layer 50 bonds the ultraviolet light blocking layer 40 and the light adjustment module 30.

For example, the surface of the light adjustment module 30 proximate to the first substrate 10 is coated with the PVB adhesive to form the first adhesive layer 50, and the PVB adhesive covers the surface of the light adjustment module 30. The second adhesive layer 60 bonds the light adjustment module 30 to the surface of the second substrate 20.

In S622, the second frame sealing adhesive 120 bonds the second substrate 20 to the light adjustment module 30.

For example, the second frame sealing adhesive 120 is bonded to the three edges of the surface of the light adjustment module 30 where the ultraviolet light blocking layer 40 is not formed, and the second frame sealing adhesive 120 bonds the light adjustment module 30 and the surface of the second substrate 20 where the second light-shielding layer 80 is not formed, so as to form a second accommodating groove with a second opening.

It can be understood that the order of steps S61 and S621, and step S622 may be exchanged. That is, S61, S621 and S622 may be performed in sequence, or S622 may be performed first, and then S61 and S621 may be performed.

In S63, the second adhesive layer 60 is formed between the second substrate 20 and the light adjustment module 30.

The second adhesive layer 60 is formed by pouring the transparent optical adhesive into the second accommodating groove through the second opening, and then the second frame sealing adhesive 120 is provided at a position of the second opening, and the second opening is sealed with the second frame sealing adhesive 120.

In S64, the sealant 90 is filled between the first substrate 10 and the second substrate 20.

The sealant 90 surrounds the light adjustment module 30, the first adhesive layer 50, and the second frame sealing adhesive 120, and is connected to the circumferential sidewall of the light adjustment module 30, the circumferential sidewall of the first adhesive layer 50, and the surface of the second frame sealing adhesive 120 away from the second adhesive layer 60.

In some embodiments, as shown in FIG. 24, the ultraviolet light blocking layer 40 is located on the surface of the first substrate 10 proximate to the light adjustment module 30. The material of the ultraviolet light blocking layer 40 may be the ultraviolet blocking optical adhesive, or cerium dioxide and titanium dioxide. The orthographic projection of the ultraviolet light blocking layer 40 on the reference plane approximately coincides with the orthographic projection of the first substrate 10 on the reference plane. The orthographic projection of the light adjustment module 30 on the reference plane is located within the orthographic projection of the ultraviolet light blocking layer 40 on the reference plane, and has a distance from the boundary of the orthographic projection of the ultraviolet light blocking layer 40 on the reference plane. The material of the first adhesive layer 50 includes the transparent optical adhesive, and the material of the second adhesive layer 60 includes the PVB adhesive. The first adhesive layer 50 is located between the ultraviolet light blocking layer 40 and the light adjustment module 30. The orthographic projection of the first adhesive layer 50 on the reference plane is located within the orthographic projection of the light adjustment module 30 on the reference plane, and has a distance from the boundary of the orthographic projection of the light adjustment module 30 on the reference plane. The first frame sealing adhesive 110 is used to adhere the light adjustment module 30 and the ultraviolet light blocking layer 40. The first frame sealing adhesive 110 is disposed around the first adhesive layer 50, and is bonded to the circumferential sidewall of the first adhesive layer 50. The orthographic projection of the second adhesive layer 60 on the reference plane approximately coincides with the orthographic projection of the light adjustment module 30 on the reference plane. The sealant 90 is disposed around the light adjustment module 30, the first frame sealing adhesive 110 and the second adhesive layer 60, and is connected to the circumferential sidewall of the light adjustment module 30, the surface of the first frame sealing adhesive 110 away from the first adhesive layer 50, and the circumferential sidewall of the second adhesive layer 60.

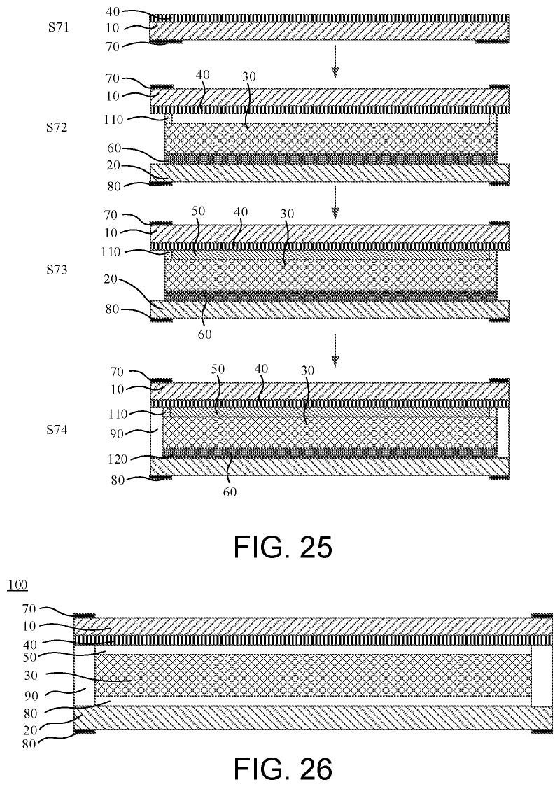

The embodiments of the present disclosure further provide a manufacturing method of the light adjustment device 100 as shown in FIG. 24. As shown in FIG. 25, the manufacturing method includes S71 to S74.

In S71, the ultraviolet light blocking layer 40 is formed on the surface of the first substrate 10 proximate to the light adjustment module 30.

For example, in a case where the light adjustment device 100 includes the first light-shielding layer 70, ink needs to be applied on an edge of a surface of the first substrate 10 to form the first light-shielding layer 70 in advance, and then the ultraviolet light blocking layer 40 is formed on another surface of the first substrate 10, and the orthographic projection of the ultraviolet light blocking layer 40 on the reference plane approximately coincides with the orthographic projection of the first substrate 10 on the reference plane.

For example, in a case where the light adjustment device 100 does not include the first light-shielding layer 70, the ultraviolet light blocking layer 40 may be formed on a surface of the first substrate 10, and the orthographic projection of the ultraviolet light blocking layer 40 on the reference plane approximately coincides with the orthographic projection of the first substrate 10 on the reference plane.

In a case where the material of the ultraviolet light blocking layer 40 includes the ultraviolet blocking optical adhesive, a vacuum bonding process may be used to form the ultraviolet light blocking layer 40 on the surface of the first substrate 10 proximate to the light adjustment module 30, and the ultraviolet blocking optical adhesive cover the surface of the first substrate 10.

In a case where the material of the ultraviolet light blocking layer 40 includes cerium dioxide and titanium dioxide, a sol-gel method or a magnetron sputtering method may be used to form the ultraviolet light blocking layer 40 on the surface of the first substrate 10 proximate to the light adjustment module 30, and cerium dioxide and titanium dioxide cover the surface of the first substrate 10.

In S72, the first substrate 10 and the second substrate 20 are bonded to the light adjustment module 30.

For example, S72 includes S721 and S722.

In S721, the first frame sealing adhesive 110 bonds the light adjustment module 30 to the ultraviolet light blocking layer 40.

For example, the first frame sealing adhesive 110 is bonded to three edges of a surface of the light adjustment module 30, and the first frame sealing adhesive 110 bonds the light adjustment module 30 to the surface of the ultraviolet light blocking layer 40 to form a first accommodating groove with a first opening.

In S722, the second adhesive layer 60 bonds the ultraviolet light blocking layer 40 and the light adjustment module 30.

For example, the surface of the light adjustment module 30 proximate to the second substrate 20 is coated with the PVB adhesive to form the second adhesive layer 60, and the PVB adhesive covers the surface of the light adjustment module 30. The first adhesive layer 50 bonds the ultraviolet light blocking layer 40 and the light adjustment module 30.

It can be understood that the order of steps S71 and S721, and step S722 may be exchanged. That is, S71, S721 and S721 may be performed in sequence, or S722 may be performed first, and then S71 and S721 may be performed.

In S73, the first adhesive layer 50 is formed between the first substrate 10 and the light adjustment module 30.

The first adhesive layer 50 is formed by pouring the transparent optical adhesive into the first accommodating groove through the first opening, and then the first frame sealing adhesive 110 is provided at a position of the first opening, and the first opening is sealed with the first frame sealing adhesive 110.

In S74, the sealant 90 is filled between the first substrate 10 and the second substrate 20.

The sealant 90 surrounds the light adjustment module 30, the first frame sealing adhesive 110, and the second adhesive layer 60, and is connected to the circumferential sidewall of the light adjustment module 30, and the surface of the first frame sealing adhesive 110 away from the first adhesive layer 50, and the circumferential sidewall of the second adhesive layer 60.

In some embodiments, as shown in FIG. 26, the orthographic projection of the ultraviolet light blocking layer 40 on the reference plane approximately coincides with the orthographic projection of the first substrate 10 on the reference plane. The orthographic projection of the light adjustment module 30 on the reference plane is located within the orthographic projection of the ultraviolet light blocking layer 40 on the reference plane, and has a distance from the boundary of the orthographic projection of the ultraviolet light blocking layer 40 on the reference plane. In a case where the light adjustment device 100 includes the first light-shielding layer 70, the inner boundary of the orthographic projection of the first light-shielding layer 70 on the reference plane is located within the orthographic projection of the light adjustment module 30 on the reference plane, and has a distance from the boundary of the orthographic projection of the light adjustment module 30 on the reference plane. Alternatively, the inner boundary of the orthographic projection of the first light-shielding layer 70 on the reference plane approximately coincides with the boundary of the orthographic projection of the light adjustment module 30 on the reference plane.

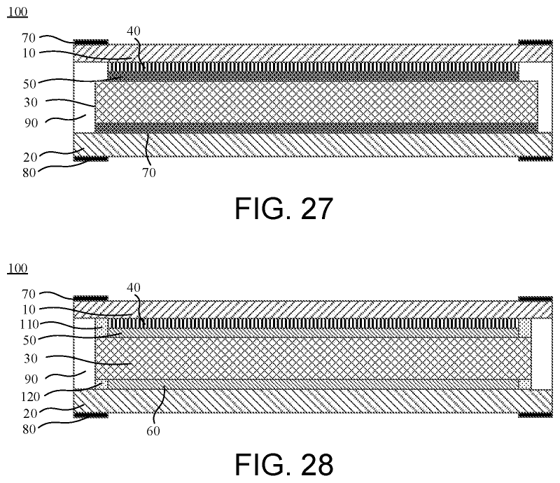

In some embodiments, as shown in FIG. 27, the ultraviolet light blocking layer 40 is located on the surface of the first substrate 10 proximate to the light adjustment module 30, and the material of the ultraviolet light blocking layer 40 may be the ultraviolet blocking optical adhesive, or cerium dioxide and titanium dioxide. The boundary of the orthographic projection of the ultraviolet light blocking layer 40 on the reference plane approximately coincides with the inner boundary of the orthographic projection of the first light-shielding layer 70 on the reference plane. The orthographic projection of the ultraviolet light blocking layer 40 on the reference plane is located within the orthographic projection of the light adjustment module 30 on the reference plane, and has a distance from the boundary of the orthographic projection of the light adjustment module 30 on the reference plane. The materials of the first adhesive layer 50 and the second adhesive layer 60 each include the PVB adhesive. The first adhesive layer 50 is located between the ultraviolet light blocking layer 40 and the light adjustment module 30. The orthographic projection of the ultraviolet light blocking layer 40 on the reference plane is located within the orthographic projection of the light adjustment module 30 on the reference plane, and has a distance from the boundary of the orthographic projection of the light adjustment module 30 on the reference plane. The orthographic projection of the first adhesive layer 50 on the reference plane approximately coincides with the orthographic projection of the ultraviolet light blocking layer 40 on the reference plane. The orthographic projection of the second adhesive layer 60 on the reference plane approximately coincides with the orthographic projection of the light adjustment module 30 on the reference plane; the sealant 90 is disposed around the light adjustment module 30, the ultraviolet light blocking layer 40, the first adhesive layer 50, and the second adhesive layer 60; and the sealant 90 is partially located between the light adjustment module 30 and the first substrate 10.

As shown in FIG. 28, the ultraviolet light blocking layer 40 is located on the surface of the first substrate 10 proximate to the light adjustment module 30. The material of the ultraviolet light blocking layer 40 may be the ultraviolet blocking optical adhesive, or cerium dioxide and titanium dioxide. The boundary of the orthographic projection of the ultraviolet light blocking layer 40 on the reference plane approximately coincides with the inner boundary of the orthographic projection of the first light-shielding layer 70 on the reference plane. The orthographic projection of the ultraviolet light blocking layer 40 on the reference plane is located within the orthographic projection of the light adjustment module 30 on the reference plane, and has a distance from the boundary of the orthographic projection of the light adjustment module 30 on the reference plane. The materials of the first adhesive layer 50 and the second adhesive layer 60 each include the transparent optical adhesive. The first adhesive layer 50 is located between the ultraviolet light blocking layer 40 and the light adjustment module 30, and the boundary of the orthographic projection of the first adhesive layer 50 on the reference plane approximately coincides with the boundary of the orthographic projection of the ultraviolet light blocking layer 40 on the reference plane. The orthographic projection of the ultraviolet light blocking layer 40 on the reference plane is located within the orthographic projection of the light adjustment module 30 on the reference plane, and has a distance from the boundary of the orthographic projection of the light adjustment module 30 on the reference plane. The first frame sealing adhesive 110 is used to adhere the light adjustment module 30 and the first substrate 10. The first frame sealing adhesive 110 is disposed around the first adhesive layer 50 and the ultraviolet light blocking layer 40, and is bonded to the first adhesive layer 50 and the circumferential sidewall of the ultraviolet light blocking layer 40. An orthographic projection, on the first substrate 10, of the second adhesive layer 60 is located within an orthographic projection, on the first substrate 10, of the light adjustment module 30, and has a distance from a boundary of the orthographic projection, on the first substrate 10, of the light adjustment module 30. The second frame sealing adhesive 120 is disposed around the second adhesive layer 60, and is bonded to the circumferential sidewall of the second adhesive layer 60. The sealant 90 is disposed around the first frame sealing adhesive 110 and the second frame sealing adhesive 120, and is connected to a circumferential sidewall of the light adjustment module 30, the surface of the first frame sealing adhesive 110 away from the first adhesive layer 50, and the surface of the second frame sealing adhesive 120 away from the second adhesive layer 60.

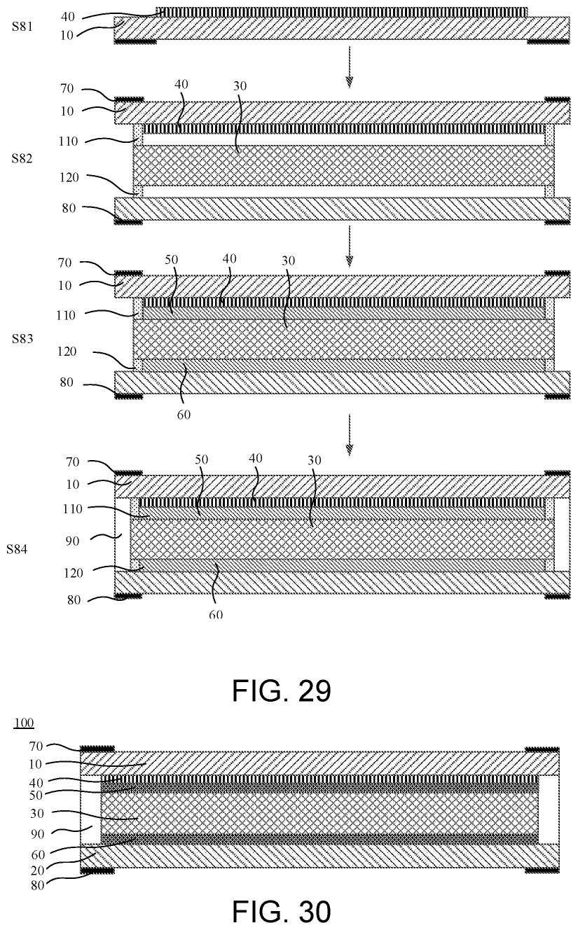

The embodiments of the present disclosure further provide a manufacturing method of the light adjustment device 100 as shown in FIG. 28. As shown in FIG. 29, the manufacturing method includes S81 to S84.

In S81, the ultraviolet light blocking layer 40 is formed on the surface of the first substrate 10 proximate to the light adjustment module 30.

For example, ink is applied on an edge of a surface of the first substrate 10 to form the first light-shielding layer 70 in advance, and then the ultraviolet light blocking layer 40 is formed on another surface of the first substrate 10. The boundary of the orthographic projection of the ultraviolet light blocking layer 40 on the reference plane approximately coincides with the inner boundary of the orthographic projection of the first light-shielding layer 70 on the reference plane.

In a case where the material of the ultraviolet light blocking layer 40 includes the ultraviolet blocking optical adhesive, a vacuum bonding process may be used to form the ultraviolet light blocking layer 40 on the surface of the first substrate 10 proximate to the light adjustment module 30.

In a case where the material of the ultraviolet light blocking layer 40 includes cerium dioxide and titanium dioxide, a sol-gel method or a magnetron sputtering method may be used to form the ultraviolet light blocking layer 40 on the surface of the first substrate 10 proximate to the light adjustment module 30.

In S82, the first substrate 10 and the second substrate 20 are bonded to the light adjustment module 30.

For example, S82 includes S821 and S822.

In S821, the first frame sealing adhesive 110 bonds the first substrate 10 to the light adjustment module 30.

For example, the first frame sealing adhesive 110 is bonded to three edges of the surface of the first substrate 10 where the ultraviolet light blocking layer 40 is formed, the first frame sealing adhesive 110 surrounds the ultraviolet light blocking layer 40, and the first frame sealing adhesive 110 bonds the surface of the light adjustment module 30 proximate to the first substrate 10 to the surface of the first substrate 10 where the ultraviolet light blocking layer 40 is formed, so as to form a first accommodating groove with a first opening.

In S822, the second frame sealing adhesive 120 bonds the second substrate 20 to the light adjustment module 30.

For example, the second frame sealing adhesive 120 is bonded to three edges of a surface of the light adjustment module 30 where the ultraviolet light blocking layer 40 is not formed, and the second frame sealing adhesive 120 bonds the light adjustment module 30 to the surface of the second substrate 20, so as to form a second accommodating groove with a second opening.

It can be understood that the order of steps S81 and S821, and step S822 may be exchanged. That is, S81, S821 and S822 may be performed in sequence; or S822 may be performed first, and then S81 and S821 may be performed.

In S83, the first adhesive layer 50 and the second adhesive layer 60 are formed.

For example, S83 includes S831 and S832.

In S831, the first adhesive layer 50 is formed between the first substrate 10 and the light adjustment module 30.

The first adhesive layer 50 is formed by pouring the transparent optical adhesive into the first accommodating groove through the first opening, and then the first frame sealing adhesive 110 is provided at a position of the first opening, and the first opening is sealed with the first frame sealing adhesive 110.

In S832, the second adhesive layer 60 is formed between the second substrate 20 and the light adjustment module 30, and then the second frame sealing adhesive 120 is provided at a position of the second opening, and the second opening is sealed with the second frame sealing adhesive 120.

The second adhesive layer 60 is formed by pouring the transparent optical adhesive into the second accommodating groove through the second opening.

It can be understood that the order of steps S831 and S832 may be interchanged. That is, S831 and S832 may be performed in sequence; or S832 may be performed first, and then S831 may be performed; or S831 and S832 may be performed simultaneously.

In S84, the sealant 90 is filled between the first substrate 10 and the second substrate 20.

The sealant 90 is disposed around the light adjustment module 30, the first frame sealing adhesive 110 and the second frame sealing adhesive 120, and is connected to the circumferential sidewall of the light adjustment module 30, the surface of the first frame sealing adhesive 110 away from the first adhesive layer 50, and the surface of the second frame sealing adhesive 120 away from the second adhesive layer 60.

In some embodiments, as shown in FIG. 30, the ultraviolet light blocking layer 40 is located on the surface of the first substrate 10 proximate to the light adjustment module 30. The material of the ultraviolet light blocking layer 40 may be the ultraviolet blocking optical adhesive, or cerium dioxide and titanium dioxide. The orthographic projection of the ultraviolet light blocking layer 40 on the reference plane approximately coincides with the orthographic projection of the light adjustment module 30 on the reference plane. The orthographic projection of the ultraviolet light blocking layer 40 on the reference plane is located within the orthographic projection of the first substrate 10 on the reference plane, and has a distance from the boundary of the orthographic projection of the first substrate 10 on the reference plane. The materials of the first adhesive layer 50 and the second adhesive layer 60 each include the PVB adhesive. The first adhesive layer 50 is located between the ultraviolet light blocking layer 40 and the light adjustment module 30, and the orthographic projection of the first adhesive layer 50 on the reference plane approximately coincides with the orthographic projection of the ultraviolet light blocking layer 40 on the reference plane. The orthographic projection of the second adhesive layer 60 on the reference plane approximately coincides with the orthographic projection of the light adjustment module 30 on the reference plane, and the sealant 90 is disposed around the light adjustment module 30, the ultraviolet light blocking layer 40, the first adhesive layer 50, and the second adhesive layer 60.

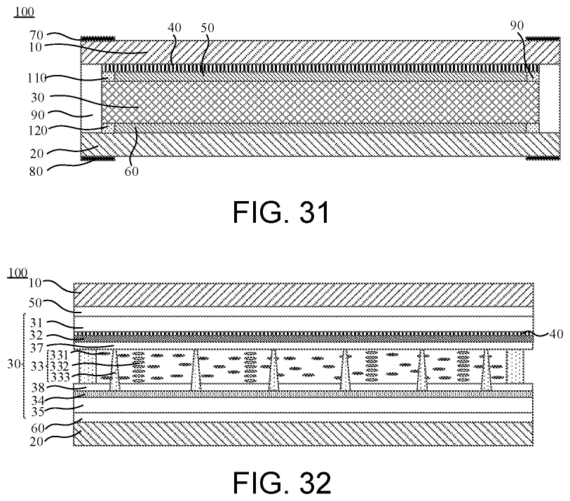

As shown in FIG. 31, the ultraviolet light blocking layer 40 is located on the surface of the first substrate 10 proximate to the light adjustment module 30. The ultraviolet light blocking layer 40 may be made of the ultraviolet blocking optical adhesive, or may be made of cerium dioxide and titanium dioxide. The orthographic projection of the ultraviolet light blocking layer 40 on the reference plane approximately coincides with the orthographic projection of the light adjustment module 30 on the reference plane. The orthographic projection of the ultraviolet light blocking layer 40 on the reference plane is located within the orthographic projection of the first substrate 10 on the reference plane, and has a distance from the boundary of the orthographic projection of the first substrate 10 on the reference plane. The materials of the first adhesive layer 50 and the second adhesive layer 60 each include the transparent optical adhesive. The first adhesive layer 50 is located between the ultraviolet light blocking layer 40 and the light adjustment module 30; and the orthographic projection of the first adhesive layer 50 on the reference plane is located within the orthographic projection of the ultraviolet light blocking layer 40 on the reference plane, and has a distance from the boundary of the orthographic projection of the ultraviolet light blocking layer 40 on the reference plane. The orthographic projection of the second adhesive layer 60 on the reference plane is located within the orthographic projection of the light adjustment module 30 on the reference plane, and has a distance from the boundary of the orthographic projection of the light adjustment module 30 on the reference plane. The first frame sealing adhesive 110 is used to adhere the light adjustment module 30 and the ultraviolet light blocking layer 40. The first frame sealing adhesive 110 is disposed around the first adhesive layer 50, and is bonded to the circumferential sidewall of the first adhesive layer 50. The second frame sealing adhesive 120 is disposed around the second adhesive layer 60, and is bonded to the circumferential sidewall of the second adhesive layer 60. The sealant 90 is disposed around the light adjustment module 30, the ultraviolet light blocking layer 40, the first frame sealing adhesive 110 and the second frame sealing adhesive 120.

In some embodiments, as shown in FIG. 32, the ultraviolet light blocking layer 40 is located between the first base material layer 31 and the first electrode layer 32. The ultraviolet light blocking layer 40 may be made of cerium dioxide and titanium dioxide. The materials of the first adhesive layer 50 and the second adhesive layer 60 each include the PVB adhesive. The first adhesive layer 50 is located between the light adjustment module 30 and the first substrate 10, the orthographic projection of the first adhesive layer 50 on the reference plane approximately coincides with the orthographic projection of the light adjustment module 30 on the reference plane, and the first adhesive layer 50 is used to adhere the light adjustment module 30 to the first substrate 10. The orthographic projection of the ultraviolet light blocking layer 40 on the reference plane approximately coincides with an orthographic projection of the first base material layer 31 on the reference plane. The orthographic projection of the second adhesive layer 60 on the reference plane approximately coincides with the orthographic projection of the light adjustment module 30 on the reference plane.

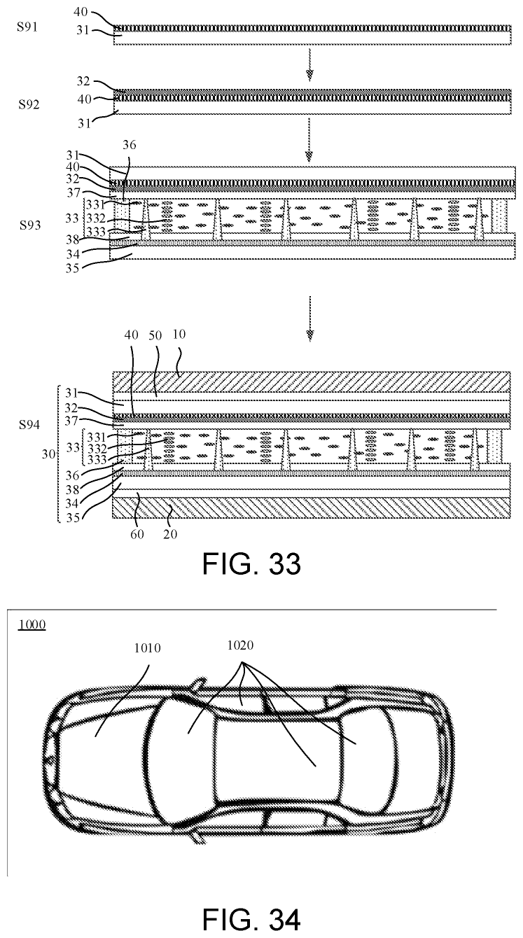

The embodiments of the present disclosure further provide a manufacturing method of the light adjustment device 100 as shown in FIG. 32. As shown in FIG. 33, the manufacturing method includes S91 to S94.

In S91, the ultraviolet light blocking layer 40 is formed on a surface of the first base material layer 31.

A surface of the first base material layer 31 is plated with cerium dioxide and titanium dioxide by a sol-gel method or a magnetron sputtering method, so as to form the ultraviolet light blocking layer 40; and the cerium dioxide and titanium dioxide cover the surface of the first base material layer 31.

In S92, the first electrode layer 32 is formed on the surface of the ultraviolet light blocking layer 40 away from the first substrate 10.

For example, a surface of the ultraviolet light blocking layer 40 is plated with a first electrode material by a sol-gel method or a magnetron sputtering method, so as to form the first electrode layer 32; and the first electrode material covers the surface of the ultraviolet light blocking layer 40. The first electrode material is the same as the material of the above first electrode layer 32.

In S93, the fabrication of the light adjustment module 30 is completed.

A surface of the second base material layer 35 is plated with a second electrode material by a sol-gel method or a magnetron sputtering method, so as to form the second electrode layer 34. The second electrode material is the same as the material of the above second electrode layer 34. The sealant 36 is arranged along an edge of the first electrode layer 32 and on a surface of the first electrode layer 32 away from the first base material layer 31, and the sealant 36 and the first electrode layer 32 form a third accommodating groove with a third opening. Then, the light adjustment layer 33 is formed by injecting an adjustment material into the third accommodating groove through the third opening. The adjustment material is the same as the material of the above light adjustment layer 33. The second electrode layer 34 is disposed at the third opening, the third opening is closed, an orthographic projection of the second electrode layer 34 on the first substrate 10 is approximately coincides with an orthographic projection of the first electrode layer 32 on the first substrate 10, and the fabrication of the light adjustment module 30 is completed.

In S94, the first substrate 10 and the second substrate 20 are bonded to the light adjustment module 30.

For example, S94 includes S941 and S942.

In S941, the first adhesive layer 50 bonds the light adjustment module 30 to the first substrate 10.

For example, the surface of the light adjustment module 30 proximate to the first substrate 10 is coated with the PVB adhesive, so as to form the first adhesive layer 50; and the PVB adhesive covers the surface of the light adjustment module 30 proximate to the first substrate 10. The first adhesive layer 50 bonds the first substrate 10 and the light adjustment module 30.

In S942, the second adhesive layer 60 bonds the second substrate 20 to the light adjustment module 30.

For example, the surface of the light adjustment module 30 proximate to the second substrate 20 is coated with the PVB adhesive, so as to form the second adhesive layer 60; and the PVB adhesive covers the surface of the light adjustment module 30 proximate to the second substrate 20. The second adhesive layer 60 bonds the second substrate 20 and the light adjustment module 30.

It can be understood that the order of steps S941 and S942 may be interchanged. That is, S941 and S942 may be performed in sequence; or S941 may be performed first, and then S942 is performed.

The embodiments of the present disclosure further provide a vehicle 1000, and as shown in FIG. 34, the vehicle includes a vehicle body 1010 and a vehicle window glass 1020 mounted on the vehicle body. The vehicle window glass 1020 may be one or more of a front window glass, a sunroof glass, a rear window glass or a side window glass of the vehicle. The vehicle window glass 1020 includes the light adjustment device 100 in any of the above-mentioned embodiments. The first substrate 10 in the light adjustment device 100 is closer to an outside of the vehicle than the second substrate 20. That is, the ultraviolet light blocking layer 40 is located on a side of the first substrate 10 proximate to a seat of the vehicle. The light adjustment device 100 may also be applied to a touch screen of a center console in the vehicle 1000.

The light adjustment device 100 may also be applied in the construction field. For example, the light adjustment device 100 is applied to a glass of a bathroom, and the light adjustment device 100 may make indoor light sufficient and protect privacy. Alternatively, the light adjustment device 100 may be applied to a glass of a partition, and compared with a brick wall, the thickness of the light adjustment device 100 is small, and the light adjustment device 100 may save space.

The foregoing descriptions are merely specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

1. A light adjustment device, comprising:
a first substrate and a second substrate that are arranged opposite to each other;
a light adjustment module located between the first substrate and the second substrate; and
an ultraviolet light blocking layer located between the first substrate and the light adjustment module or disposed in the light adjustment module;
wherein a refractive index of the ultraviolet light blocking layer is greater than a refractive index of the first substrate.

2. The light adjustment device according to claim 1, wherein the ultraviolet light blocking layer is disposed on a surface of the light adjustment module proximate to the first substrate; the light adjustment device further comprises:
a first adhesive layer located between the ultraviolet light blocking layer and the first substrate;
wherein a refractive index of the first adhesive layer is greater than the refractive index of the first substrate, and is less than the refractive index of the ultraviolet light blocking layer.

3. The light adjustment device according to claim 2, wherein
the refractive index of the first substrate is in a range of 1.3 to 1.5; and/or
the refractive index of the first adhesive layer is in a range of 1.4 to 1.5; and/or
the refractive index of the ultraviolet light blocking layer is in a range of 1.4 to 1.6.

4. The light adjustment device according to claim 2, wherein the light adjustment module includes a first base material layer and a second base material layer that are arranged opposite to each other; the first base material layer is closer to the first substrate than the second base material layer; the ultraviolet light blocking layer is disposed on a surface of the first base material layer away from the second base material layer;
a thermal expansion coefficient of the ultraviolet light blocking layer is approximately the same as a thermal expansion coefficient of the first base material layer; and/or
a heat shrinkage of the ultraviolet light blocking layer is approximately the same as a heat shrinkage of the first base material layer.

5. The light adjustment device according to claim 4, wherein the thermal expansion coefficient of the ultraviolet light blocking layer is less than or equal to 50 ppm/K; and/or the heat shrinkage of the ultraviolet light blocking layer is less than or equal to 0.1%.

6. The light adjustment device according to claim 1, wherein the ultraviolet light blocking layer is disposed on a surface of the first substrate proximate to the light adjustment module; the light adjustment device further comprises:
a first adhesive layer located between the ultraviolet light blocking layer and the light adjustment module;
wherein a refractive index of the first adhesive layer is greater than the refractive index of the ultraviolet light blocking layer.

7. The light adjustment device according to claim 6, wherein
the refractive index of the first substrate is in a range of 1.3 to 1.5; and/or
the refractive index of the ultraviolet light blocking layer is in a range of 1.4 to 1.5; and/or
the refractive index of the first adhesive layer is in a range of 1.4 to 1.6.

8. The light adjustment device according to claim 1, wherein an orthographic projection of the ultraviolet light blocking layer on a reference plane approximately coincides with an orthographic projection of the light adjustment module on the reference plane, and the reference plane is approximately parallel to a surface of the first substrate away from the light adjustment module.

9. The light adjustment device according to claim 1, further comprising:
a first light-shielding layer disposed on a surface of the first substrate away from the light adjustment module or a surface of the first substrate proximate to the light adjustment module and arranged along an edge of the first substrate;
wherein a boundary of an orthographic projection of the ultraviolet light blocking layer on a reference plane approximately coincides with an inner boundary of an orthographic projection of the first light-shielding layer on the reference plane, and the reference plane is approximately parallel to the surface of the first substrate away from the light adjustment module.

10. The light adjustment device according to claim 8, further comprising:
a sealant located between the first substrate and the second substrate and surrounding the light adjustment module, the first adhesive layer and the ultraviolet light blocking layer.

11. The light adjustment device according to claim 6, an orthographic projection of the ultraviolet light blocking layer on a reference plane approximately coincides with an orthographic projection of the first substrate on the reference plane, and the reference plane is approximately parallel to a surface of the first substrate away from the light adjustment module.

12. The light adjustment device according to claim 11, further comprising:
a sealant located between the ultraviolet light blocking layer and the second substrate and surrounding the light adjustment module and the first adhesive layer.

13. The light adjustment device according to claim 1, wherein the light adjustment module includes a first base material layer, a first electrode layer, a light adjustment layer, a second electrode layer and a second base material layer that are sequentially stacked; the first base material layer is closer to the first substrate than the second base material layer; the ultraviolet light blocking layer is located between the first base material layer and the first electrode layer; and a material of the ultraviolet light blocking layer includes cerium dioxide and titanium dioxide;
or
a material of the ultraviolet light blocking layer includes an ultraviolet blocking optical adhesive; and/or the material of the ultraviolet light blocking layer includes cerium dioxide and titanium dioxide.

14. (canceled)

15. The light adjustment device according to claim 13, wherein
in a case where the material of the ultraviolet light blocking layer includes the ultraviolet blocking optical adhesive, a thickness of the ultraviolet light blocking layer is in a range of 50 μm to 200 μm; and
in a case where the material of the ultraviolet light blocking layer includes cerium dioxide and titanium dioxide, the thickness of the ultraviolet light blocking layer is in a range of 400 nm to 600 nm.

16. The light adjustment device according to claim 1, wherein the light adjustment device comprises a first adhesive layer and a second adhesive layer; the first adhesive layer is disposed between the light adjustment module and the first substrate; and the second adhesive layer is disposed between the light adjustment module and the second substrate;
wherein a material of the first adhesive layer includes a polyvinyl butyral (PVB) adhesive or a transparent optical adhesive; and/or
a material of the second adhesive layer includes a PVB adhesive or a transparent optical adhesive.

17. The light adjustment device according to claim 16, wherein the material of the first adhesive layer includes the PVB adhesive, an orthographic projection of the first adhesive layer on a reference plane approximately coincides with an orthographic projection of the light adjustment module on the reference plane, and the reference plane is approximately parallel to a surface of the first substrate away from the light adjustment module;
the light adjustment device further comprises a sealant, and the sealant surrounds the light adjustment module and the first adhesive layer, and is connected to a circumferential sidewall of the light adjustment module and a circumferential sidewall of the first adhesive layer.

18. The light adjustment device according to claim 16, wherein the material of the first adhesive layer includes the transparent optical adhesive; an orthographic projection of the first adhesive layer on a reference plane is located within an orthographic projection of the light adjustment module on the reference plane, and has a distance from a boundary of the orthographic projection of the light adjustment module on the reference plane; the reference plane is approximately parallel to a surface of the first substrate away from the light adjustment module;
the light adjustment device further comprises a first frame sealing adhesive disposed around the first adhesive layer and bonded to a circumferential sidewall of the first adhesive layer;
the light adjustment device further comprises a sealant, and the sealant surrounds the light adjustment module and the first frame sealing adhesive, and is connected to a circumferential sidewall of the light adjustment module and a surface of the first frame sealing adhesive away from the first adhesive layer.

19. The light adjustment device according to claim 16, wherein the material of the second adhesive layer includes the PVB adhesive, an orthographic projection of the second adhesive layer on a reference plane approximately coincides with an orthographic projection of the light adjustment module on the reference plane, and the reference plane is approximately parallel to a surface of the first substrate away from the light adjustment module;
the light adjustment device further comprises a sealant, and the sealant surrounds the light adjustment module and the second adhesive layer, and is connected to a circumferential sidewall of the light adjustment module and a circumferential sidewall of the second adhesive layer.

20. The light adjustment device according to claim 16, wherein the material of the second adhesive layer includes the transparent optical adhesive; an orthographic projection of the second adhesive layer on a reference surface is located within an orthographic projection of the light adjustment module on the reference plane, and has a distance from a boundary of the orthographic projection of the light adjustment module on the reference plane; the reference plane is approximately parallel to a surface of the first substrate away from the light adjustment module;
the light adjustment device further comprises a second frame sealing adhesive disposed around the second adhesive layer and bonded to a circumferential sidewall of the second adhesive layer;
the light adjustment device further comprises a sealant, and the sealant surrounds the light adjustment module and the second frame sealing adhesive, and is connected to a circumferential sidewall of the light adjustment module and a surface of the second frame sealing adhesive away from the second adhesive layer.

21. A vehicle, comprising a vehicle body and a vehicle window glass mounted on the vehicle body, the vehicle window glass including the light adjustment device according to claim 1, wherein the first substrate is closer to an outside of the vehicle than the second substrate.
